(19) United States
(12) Patent Application Publication
(10) Pub. No.: US 2026/0312425 A1
(43) Pub. Date: Oct. 8, 2026

(54) ENERGY STORAGE SYSTEMS AND METHODS FOR TRANSFORMER HEALTH MONITORING AND PREDICTIVE MAINTENANCE

(71) Applicant: LG Energy Solution, Ltd., Seoul (KR)

(72) Inventor: Dinesh Kumar Murugesan, Westborough, MA (US)

(73) Assignee: LG Energy Solution, Ltd., Seoul (KR)

(21) Appl. No.: 19/640,164

(22) Filed: Apr. 6, 2026

Related U.S. Application Data
(60) Provisional application No. 63/784,848, filed on Apr. 7, 2025.

(51) Int. Cl. H02J 13/12

(52) U.S. Cl. CPC H02J 13/12

(57) ABSTRACT

A method for transformer health monitoring in a battery energy storage system includes receiving, by one or more processors, a data set associated with an inverter and a grid connected to a transformer. The method includes determining one or more threshold values based on one or more of a winding health index or a tap changer health index associated with the transformer. The method includes applying, by the one or more processors, a machine learning model to the data set to generate a determination that the data set meets the one or more threshold values associated with a health assessment of the transformer, wherein the machine learning model is configured to predict the winding health index or the tap changer health index at one or more intervals. The method includes controlling, by the one or more processors, one or more operations of the transformer based on the determination.

### CROSS-REFERENCE TO RELATED APPLICATIONS

This application claims benefit to U.S. Provisional Patent Application No. 63/784,848 filed Apr. 7, 2025, the contents of which are incorporated by reference in its entirety.

### TECHNICAL FIELD

Various embodiments of the present disclosure relate generally to systems and methods for battery energy storage system monitoring and control, and more particularly to machine learning-based health assessment and prediction for power conversion systems and transformers in battery energy storage systems.

### BACKGROUND

Battery Energy Storage Systems (BESS) have emerged as critical components in modern energy infrastructure. As renewable energy sources such as wind and solar power become increasingly integrated into electrical grids, their inherent intermittency creates challenges for grid stability and efficient power distribution. Beyond renewable energy applications, BESS also provides significant benefits for conventional energy generation systems by enabling load leveling, frequency regulation, and peak shaving for traditional power plants including coal, natural gas, and nuclear facilities. These systems help conventional generators operate more efficiently by reducing the need for rapid ramping, and by providing grid services that improve overall system reliability. BESS technology addresses these challenges by storing excess electricity generated during periods of low demand and releasing it during peak demand periods. This capability optimizes energy usage by reducing curtailment of renewable electricity, improving efficiency of (and reducing reliance on) fossil fuel-based power generation such as gas turbines, and supports climate change mitigation efforts by reducing greenhouse gas emissions. The importance of BESS technology continues to grow as the global energy transition accelerates and intermittent renewable sources capture larger shares of the electricity supply mix.

Commercially available batteries may include nickel-cadmium batteries, nickel-hydrogen batteries, nickel-zinc batteries, lithium, sodium-ion, lithium iron phosphate, lithium-sulfur, solid-state batteries, and the like. Among these, lithium batteries may be gaining attention due to their advantageous characteristics: they can be charged and discharged freely without memory effects, they exhibit very low self-discharge rates, and they provide high energy density compared to nickel-based alternatives. Similarly, sodium-ion batteries are emerging as promising alternatives to lithium batteries, driven by the abundance of sodium resources and their potential cost advantages.

In general, battery packs or racks typically comprise multiple cells or cell stacks arranged in series or parallel configurations. Each cell or cell stacks contains either a single battery cell or multiple battery cells connected in series. The operational state of each cell stack within the battery pack is continuously monitored by a controller equipped with a battery management system. Battery cells may be integrated directly into packs or racks, or alternatively organized into modules, with these modules then connected in series or parallel arrangements to form complete battery packs or racks. The state of each cell stack included in the battery pack may be monitored by a controller having a battery management system mounted thereon. The controller may output signals for controlling the balancing operation, cooling operation, and discharging operation based on the monitored state from each cell stack.

Conventional energy storage systems are typically configured in containerized units, where each container housing may include multiple battery racks, switchboards, HVAC systems, thermal runaway detection systems, fire suppression systems, ventilation equipment, power distribution units, monitoring sensors, safety interlocks, and other components. These containers are designed with sufficient capacity to accommodate all necessary energy storage system components within their structure. At grid scale, BESS units may be used to store reserve power to even power entire cities in the event of blackouts or other interruptions in electrical service.

Current BESS topology includes batteries connected to a power conversion system (PCS) or inverter, which converts direct current from the batteries to alternating current for grid connection. The PCS is connected to a medium voltage transformer that steps up the voltage for connection to the electrical grid. Information can be gathered from batteries and inverters through various sensors to monitor system performance and operational parameters. However, transformers in BESS installations often lack direct monitoring capabilities, making assessment of transformer health and performance challenging.

Many BESS may lack determining or predicting the health and thermal behavior of system components, including batteries, inverters, and transformers. Without predictive health assessment capabilities, maintenance practices tend to be reactive rather than proactive. This reactive approach can result in unexpected component failures, extended system downtime, and increased maintenance costs. For medium voltage transformers, which may have lead times of approximately one year for replacement, unexpected failures can significantly impact site operations and energy delivery commitments.

Existing transformer monitoring solutions often require specialized equipment installation and direct sensor deployment on transformer components. These approaches can be costly to implement and may not be practical for all BESS installations. Additionally, conventional monitoring methods may miss early-stage degradation patterns that could provide advance warning of potential component failures. The lack of comprehensive health assessment tools for BESS components limits the ability to optimize maintenance scheduling and prevent unplanned outages.

The present disclosure is directed to overcoming one or more of these above-referenced challenges.

### SUMMARY OF THE DISCLOSURE

In some aspects, the techniques described herein relate to a method comprising: receiving, by one or more processors, a data set associated with an inverter and a grid connected to a transformer; determining one or more threshold values based on one or more of winding health index or a tap changer health index associated with the transformer; applying, by the one or more processors, a machine learning model to the data set to generate a determination that the data set meets the one or more threshold values associated with a health assessment of the transformer, wherein the machine learning model is configured to predict the winding health index or the tap changer health index at one or more intervals; and controlling, by the one or more processors, one or more operations of the transformer based on the determination that the data set meets the one or more threshold values associated with the health assessment of the transformer.

In some aspects, the techniques described herein relate to a method wherein the machine learning model is trained by: receiving first data regarding one or more first element attributes and second data regarding one or more second element attributes, wherein the first data is associated with the inverter and the second data is associated with the grid; extracting, by the one or more processors, one or more first features from the first data and extracting one or more second features from the second data; and training the machine learning model to determine a correlation between the one or more first element attributes, the one or more second element attributes, and the health assessment, based on the one or more first features and the one or more second features.

In some aspects, the techniques described herein relate to a method wherein the machine learning model is further trained by: receiving third data regarding the health assessment related to the one or more first element attributes and the one or more second element attributes, wherein the health assessment is based on one or more operational values associated with one or more components of the inverter included in the first data and one or more output values associated with the grid; extracting a third feature from the third data; and training the machine learning model to determine a correlation between the one or more first element attributes, the one or more second element attributes, and the health assessment, based on the one or more first features, the one or more second features, and the third feature.

In some aspects, the techniques described herein relate to a method wherein the one or more first features include one or more of a core issue analysis for the one or more components of the inverter, an overfluxing value, a DC bias value, an indirect cooling assessment value, or one or more ground faults, wherein the one or more second features include one or more of a voltage sag, a voltage swell, an underfrequency value, an over frequency value, or a power quality value.

In some aspects, the techniques described herein relate to a method wherein extracting the one or more first features or the one or more second features includes: determining, by the one or more processors, one or more parameters for the first data and the second data, wherein the one or more parameters includes one or more of an imbalance ratio or a power factor variation associated with the transformer; determining, by the one or more processors, one or more correlations based on the one or more parameters for the first data and the second data, wherein the one or more correlations include one or more of a primary relationship, a secondary relationship, a cross-phase pattern, or a load impact associated with the transformer; determining, by the one or more processors, a temporal tracking value based on the one or more correlations associated with the transformer; determining, by the one or more processors, a load response based on the temporal tracking value associated with the transformer; and generating, by the one or more processors, the winding health index based on one or more of the one or more parameters, the one or more correlations, the temporal tracking value, and the load response with the transformer.

In some aspects, the techniques described herein relate to a method wherein determining the temporal tracking value further includes: analyzing long-term trends associated with the transformer; performing pattern recognition based on the long-term trends; and detecting one or more anomalies in the first data and the second data over a predetermined time period to identify degradation patterns in the transformer.

In some aspects, the techniques described herein relate to a method wherein extracting the one or more first features or the one or more second features includes: determining, by the one or more processors, a contact analysis for the first data and the second data associated with the transformer; determining, by the one or more processors, one or more of a resistance tracking value, an arcing signature, or a voltage deviation based on the contact analysis associated with the transformer; determining, by the one or more processors, a current response value based on one or more of the resistance tracking value, the arcing signature, or the voltage deviation associated with the transformer; determining, by the one or more processors, one or more performance metric values based on the current response value associated with the transformer; and generating, by the one or more processors, the tap changer health index based on one or more of the contact analysis, the current response value, or the one or more performance metric values associated with the transformer.

In some aspects, the techniques described herein relate to a method further comprising: generating, by the one or more processors, a notification based on the determination that the data set meets the one or more threshold values; and outputting, by the one or more processors, the notification.

In some aspects, the techniques described herein relate to a method wherein the notification includes one or more of an early fault warning with failure progression prediction, a time-to-maintenance estimation, a risk level classification, or one or more actionable maintenance recommendations specific to identified transformer degradation patterns.

In some aspects, the techniques described herein relate to a method wherein the one or more operations of the transformer include one or more of outputting a notification, scheduling a maintenance request, preventing one or more actions associated with the transformer, or optimizing the one or more operations of the transformer.

In some aspects, the techniques described herein relate to a method wherein determining the one or more threshold values further includes: determining the one or more threshold values based on one or more component-specific health scores associated with one or more components of the inverter.

In some aspects, the techniques described herein relate to a method wherein the one or more intervals includes one or more of a day, a week, or a month.

In some aspects, the techniques described herein relate to a method wherein the data set includes one or more of a DC bus voltage measurement, a DC current measurement from multiple power stacks, an AC current measurement for each phase, one or more power factor values, an apparent power measurement, an active power measurement, a reactive power measurement, a line-to-line voltage measurement, a grid frequency measurement, or an insulation monitoring device reading.

In some aspects, the techniques described herein relate to a method wherein the machine learning model executes in real-time processing cycles of approximately one minute and includes a dynamic threshold adjustment to adapt the one or more threshold values based on the data set.

In some aspects, the techniques described herein relate to a method for transformer health monitoring in a battery energy storage system, the method comprising: receiving, by one or more processors, operational data from a transformer connected to a power conversion system of the battery energy storage system; applying, by the one or more processors, a machine learning model to the operational data from the transformer to generate a determination that the operational data meets one or more threshold values associated with a transformer health assessment, wherein applying the machine learning model to the operational data includes: detecting, by the one or more processors, insulation resistance degradation patterns in the operational data, detecting, by the one or more processors, partial discharge activity based on voltage stress indicators in the operational data, and generating, by the one or more processors, the transformer health assessment based on the insulation resistance degradation patterns and the partial discharge activity; and initiating, by the one or more processors, a maintenance action when the transformer health assessment meets the one or more threshold values.

In some aspects, the techniques described herein relate to a method wherein detecting the insulation resistance degradation patterns includes analyzing changes in one or more properties of the transformer over time and correlating temperature cycling effects with insulation aging.

In some aspects, the techniques described herein relate to a method wherein detecting the partial discharge activity includes analyzing high-frequency transients and electromagnetic patterns that indicate discharge within the transformer.

In some aspects, the techniques described herein relate to a method for training a machine learning model to predict a health of a transformer in a battery energy storage system, the method comprising: receiving, by one or more processors, first data regarding one or more element attributes associated with the transformer, wherein the first data includes a plurality of operational parameters; extracting, by the one or more processors, one or more first features from the first data based on analyzing processing algorithms identifying one or more inverter operational parameters; extracting, by the one or more processors, one or more second features from second data, wherein the second data includes one or more grid operational parameters; training, by the one or more processors, the machine learning model to determine correlations between the one or more element attributes and one or more health assessment values based on the one or more first features and the one or more second features; and validating, by the one or more processors, the trained machine learning model using validation data.

In some aspects, the techniques described herein relate to a method wherein the plurality of operational parameters include one or more of a plurality of DC bus voltage measurements, a plurality of multi-stack current readings, a plurality of three-phase AC measurements, a plurality of line-to-line measurements, or a plurality of grid voltage measurements.

In some aspects, the techniques described herein relate to a method wherein the one or more health assessment values include one or more of a winding health index, a tap changer index, a contact analysis, or a performance metrics value.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a battery, according to one or more embodiments.

FIG. 2 depicts a battery, according to one or more embodiments.

FIG. 3 depicts a controller, according to one or more embodiments.

FIG. 4 depicts a flow diagram for training a machine learning model, according to one or more embodiments.

FIG. 5 depicts a battery energy storage and power conversion system infrastructure, according to one or more embodiments.

FIG. 6 depicts tables with sample data parameters from a power conversion system, according to one or more embodiments.

FIG. 7 depicts an exemplary flow diagram for a health monitoring and control system, according to one or more embodiments.

FIG. 8 depicts an exemplary flow diagram for a health monitoring and control process, according to one or more embodiments.

FIG. 9 depicts an exemplary flow diagram for training the machine learning model of FIG. 8, according to one or more embodiments.

FIG. 10 depicts an exemplary flow diagram for generating a winding health index, according to one or more embodiments.

FIG. 11 depicts an exemplary flow diagram for generating a tap changer health index, according to one or more embodiments.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for battery energy storage system monitoring and control, and more particularly to machine learning-based health assessment and prediction for power conversion systems and transformers in battery energy storage systems.

Batteries may have a variety of shapes, also known as form factors. Common battery form factors include pouch-type, prismatic-type, and cylindrical-type.

Pouch-type battery cells can be produced in various lengths and widths, which may enhance the battery capacity and allow optimization of battery cells. The flexible pouch-type battery can provide significant advantages over rigid battery formats, including improved mechanical flexibility that allows the battery to conform to curved or irregular surfaces in electronic devices. This flexibility enables manufacturers to integrate pouch-type batteries into compact spaces and unconventional form factors, such as wearable devices, smartphones with curved displays, and automotive applications where space constraints require batteries to fit around other components. The lightweight and thin profile of pouch-type batteries also facilitates easier incorporation into products where weight and thickness are critical design considerations, such as tablets, laptops, and electric vehicle applications. Additionally, the pouch format allows for more efficient use of available space within a device enclosure, as the flexible packaging can be shaped to increase energy density while reducing wasted volume compared to cylindrical or prismatic battery formats.

Prismatic battery cells offer may offer advantages in applications requiring efficient space utilization and thermal management. Their rectangular form factor allows for optimal packing density within battery modules and packs, reducing wasted space and enabling higher energy density per unit volume. The flat surfaces of prismatic cells may facilitate improved heat dissipation and thermal contact with cooling systems, which can enhance overall battery performance and safety. The outer shell of prismatic cells are typically made of aluminum alloy or steel, and are typically heavier than pouch-type battery cells, making them ideal for situations where weight is a less important design consideration.

Cylindrical battery cells may provide robust mechanical strength and proven manufacturing scalability that may benefit high-volume production applications. The cylindrical geometry distributes internal pressure more evenly during charging and discharging cycles, potentially contributing to enhanced structural integrity and longer cycle life. These cells may also offer advantages in automated manufacturing processes due to their uniform shape and established production techniques, which can result in consistent quality and cost-effective mass production. Cylindrical cells are typically heavier than prismatic cells, and further have reduced energy density, as packing the batteries together typically results in gaps or spaces between the cells that are not present in pouch and prismatic form factor designs.

Modules and packs can be produced in various designs to accommodate various products. Batteries may include one or more of a tab structure, a tab-less structure, or a jelly roll design. A tab-less jelly roll design may reduce resistance while increasing power output. A zig-zag stacking design may include cross-stacking technology that alternates cathode and anode sheets with separators, enhancing both precision and safety. A Cell Array Structure (CAS) structure for batteries may increase structural rigidity, enhance cooling efficiency, and ensure superior safety.

The assembly of the "cylindrical battery", the most commonly encountered battery form in our daily life, starts with "winding". Winding is a process where a machine called a winder rolls up the cathode and anode electrodes. This process has the advantage of being very fast, similar to how a "tissue roll" can quickly wrap the paper around the tissue core. During winding, cathode, anode, and separator rolls are unwound, and an aluminum tab is attached to the cathode's blank part while a copper tab is attached to the anode's blank part. Then they are attached to the winder in the order of cathode-separator-anode-separator, wound around a mandrel, like rolling toilet paper around its core, and then cut into an appropriate size to form a jelly roll.

Once the jelly roll is formed, it goes through various assembly processes to take the form of the familiar cylindrical battery. At first, the jelly roll produced by the winding method is inserted into a can so that the anode touches its bottom and the anode tab is bent at a 90-degree angle to make contact with the anode. After inserting the jelly roll into the can, it is attached using a resistance welding method. Resistance welding is also known as "spot welding" because bead-like spots are created when the metal melts and solidifies. After welding, a process called "beading" is used to create the neck of the cell, allowing the top cap to be fitted later.

Once the cylindrical shape of the battery is completed through beading, electrolyte is injected. To do this, a vacuum is created inside of the can and the electrolyte is injected into it through a nozzle. Then, the can is pressed to let the electrolyte fill the pores of the electrode. Once the electrolyte injection is complete, the cathode tab and the top cap are attached to the cell using laser welding. Finally, the cylindrical battery is completed by mechanically sealing it through the crimping and sizing processes, producing it to standardized dimensions. After the assembly process is completed, the battery undergoes cleaning, quality verification, and formation processes before being delivered to the customers.

Pouch-type batteries may be manufactured differently from cylindrical batteries. To place battery materials into the electrode pocket of a pouch case, a mono-cell is required. A mono-cell is the basic unit of a battery, consisting of a cathode, an anode, and two separators arranged in a layered structure, such as "separator - central electrode - separator - external electrode." The lamination and stacking processes are applied to this mono-cell. To be more specific, the process begins with lamination, a method for aligning and bonding the cathode, anode, and separator. This is followed by stacking, during which monocells are repeatedly layered. Finally, stacking half-cells - each made up of two separators and an anode - forms a cell stack, where the cathode and anode are alternately layered with separators in between. Lamination & stacking technology increases space efficiency within the pouch case, further enhancing energy density. Stacking, which involves individually layering battery cells, requires advanced technical expertise. By applying lamination & stacking, misalignment between cells is reduced, and empty spaces within the battery cell are eliminated, resulting in higher energy density. Lamination & stacking technology with mono-cells may be used to produce a range of pouch-type batteries, from ultra-thin batteries under 2mm to long cells.

The cell stack, produced through lamination and stacking, then moves to the packaging stage. First, leads are welded onto the cell stack, which comprises multiple layers of mono-cells. Next, a pouch film is compressed to form a pocket, and the lead-welded cell stack is inserted into this pouch pocket for assembly. To seal the pocket, heat and pressure are applied using a sealing tool.

During this process, two pockets are formed: the electrode pocket and the gas pocket. The electrode pocket houses the cell stack, including the cathode, anode, separator, and electrolyte. The gas pocket, meanwhile, serves as an entry for electrolyte injection and as a space to store gases generated during the injection process. After injecting the electrolyte into the gas pocket, the injection port is sealed with the sealing tool, completing the assembly of the pouch-type battery. In the following formation process, any unwanted gases that are generated and accumulated in the gas pocket are removed during the degassing stage by trimming the gas pocket.

Prismatic battery cell manufacturing may share some similarities with cylindrical cell production, while incorporating unique processes tailored to the rectangular form factor. The manufacturing process typically begins with electrode preparation, where cathode and anode materials are coated onto current collectors, similar to other battery types. However, prismatic cells may utilize either a winding process similar to cylindrical cells or a stacking process similar to pouch cells, depending on the specific design requirements and manufacturer preferences. The electrode assembly is then inserted into a rigid metal casing, which may be made of aluminum alloy or steel, providing structural integrity that differs from the flexible pouch format.

The assembly and sealing processes for prismatic cells may involve specialized techniques that accommodate the rectangular geometry and rigid housing. Electrolyte injection in prismatic cells may require precise control to ensure uniform distribution throughout the rectangular cell structure, which can be more challenging than the cylindrical geometry due to potential dead zones in corners. The sealing process typically involves laser welding or mechanical crimping of the metal casing, providing a hermetic seal that may offer enhanced safety compared to pouch cells but requires more complex manufacturing equipment than cylindrical cells. Quality control and formation processes for prismatic cells may need to account for the unique thermal and electrical characteristics of the rectangular form factor, potentially requiring different testing protocols compared to cylindrical or pouch cell manufacturing.

After completion of the formation and acquiring electrical characteristics, batteries are either delivered as individual cells or modularized to suit (or fit) electric vehicle models. The pack process involves modularizing the battery cells and placing them into packs before final delivery.

The first step in the pack process is to bundle battery cells to build a module. First, several surface-cleaned battery cells are arranged in a "cell to cell" configuration, which are retained into a module case with adhesives. Then bus bars and leads are welded to connect to the cells with a laser welder, and the module build is completed with installing module top cover. Finally, a pack build is completed when these modules are placed into the battery pack enclosures and connected each other. These complete battery packs are then installed in many applications such as electric vehicles and various IT devices. The number of cells and modules in a battery pack may vary, depending on the battery cells and application models.

Because a battery pack contains multiple cells or modules, balancing and managing these cells is critical, especially to accurately measure state of charge and optimize battery life. Therefore, once a pack is assembled, the battery is monitored, and its performance maintained in optimal conditions using a control system called BMS (Battery Management System), which estimates the battery's charging state and life. The CMS (Cell Monitoring System) inside the BMS measures the cells' condition and performs balancing to ensure optimal battery performance, safety, and life.

"Cell balancing" refers to adjusting the voltage differences between two or more serially connected cells. For instance, if two cells connected in series reach voltages of 4.2V and 4.0V, respectively, during charging, cell balancing adjusts this 0.2v difference to equalize the voltage. Voltage imbalance can occur due to manufacturing or external factors, and it can affect battery capacity and life, posing risks of overcharging, over-discharging, and fire hazards. Hence, cell balancing is essential.

Mobility and IT battery products have a wide variety of applications in IT devices such as smartphones and laptops, as well as LEVs (Light Electric Vehicles), electric bicycles, power tools, and wireless earphones. In general, energy is difficult to store and is lost after being used. Energy Storage Systems (ESS) are systems that store and manage energy so the energy can be used more efficiently. ESS has applications in power plants, power transmission and distribution facilities, homes, factories, and businesses. Through a system that is coupled with renewable energy, ESS can increase the efficiency of renewable energy and reduce electricity costs. ESS can also be used as backup power to reduce damages from power outages.

For example, solar modules installed on the roof of homes and ESS for uninterruptible power supply (UPS) in data centers store power and use the stored power during times of high demand or when electricity prices are high. In turn, ESS reduces damages from blackouts and saves electricity bills. Also, power plants can store and manage irregularly produced renewable energy, such as solar, wind, and hydroelectric power, which increases the efficiency of their use.

When used in conjunction with solar panel installations at home, ESS stores electricity produced by solar panels during daytime to be used at nighttime. A home battery may be a solution that can serve as an alternative energy source to reduce electricity costs and prepare for power outages. Installing ESS and solar power systems together generates power independently, increasing the self-consumption of power at home and reducing the overall electricity cost.

ESS for power grids, also commonly referred to as BESS, may be installed proximate to thermal power plants, solar and wind power plants, and substations. ESS for power grids has various applications in reducing power load, coupling with renewable power generation, and adjusting power frequency. Commercial ESS installed in commercial buildings such as offices, schools, factories, data centers, and the like may be used to reduce power load, or may be coupled with renewable power generation. ESS may include backup power solutions that protect facilities that require the constant supply of power, such as data centers and IT/telecommunications facilities. ESS may also be used to enable participation in an optimized energy marketplace, where excess power is sold back to the grid during peak hours and charged during off-peak hours. While BESS is ideal for use with renewable energy systems, BESS can store energy from many different sources, including energy generated by fossil fuels, hydropower, or any other power source that generates usable electricity.

An ESS is a system that stores electricity produced and supplies it when needed, thereby enhancing energy efficiency. It mainly includes four components: a battery, a power conversion system (PCS), a battery management system (BMS), and an energy management system (EMS). The PCS is a power conversion device that converts alternating current to direct current and vice versa. The BMS is a battery management system that typically monitors and/or controls one or more battery cells, packs, racks, and/or modules in the ESS, and includes safety features that stop charging and discharging if abnormalities in voltage, current, or temperature are detected. The EMS is a system that monitors the amount of electricity stored in the ESS and serves as a software responsible for the overall operation of the ESS.

There are three primary roles of ESS. First, it acts as an uninterrupted power supply in places where power outages must be avoided at all costs, such as hospitals and banks. In cases of power outages caused by typhoons or fires, it assists in power supply to prepare for large-scale blackout situations. Second, it stores generated energy and supplies it during peak power demand times. It helps to stabilize energy output by compensating for the inconsistent generation levels of new renewable energies such as solar and wind power. In homes, it can save on electricity bills by storing electricity during cheaper hours and using it during more expensive daytime hours. Third, it maintains the standard power frequency at 60 Hz in the power supply system, countering frequency fluctuations due to mismatches in supply and demand, thereby enhancing power quality.

A battery system may include controlling power to and from batteries and providing control signals. A battery energy storage system (BESS) may include a battery management system (BMS), a local energy management system (EMS), external data reporting, a power plant controller, a utility EMS, and fleet-level controls. The BMS may collect inputs from battery cells and modules, and may operate individual cells or groups of cells. The BMS may include a controller. The BMS may balance voltages in the battery cells, for example. The local EMS may collect information from the BMS, and may control the operations of the BMS at a system level. The EMS may determine available power and capacity of the BESS, for example. External data reporting may include components such as transformers, switchgear, or meters. The power plant controller may coordinate the local EMS with a supervisory system. The utility EMS may control an electrical grid connected to the BESS. The fleet-level controls may coordinate to operate multiple BESS’s at different locations. Communications between these components may be established wirelessly or through connected wires, depending on the system configuration and operational requirements.

BMS is a management system to monitor and control the status of batteries to operate them under optimal conditions. It measures the current, voltage, and temperature of batteries in Battery Electric Vehicles (BEVs) or Energy Storage Systems (ESS) with sensors, and identifies and controls potential concerns so that the batteries can maintain the highest performance possible. The location of the BMS can vary depending on the battery type or product.

The battery system includes the cell as the smallest unit, the module of a group of cells, and the pack of the final form of the battery. The role of BMS in a battery can be compared to that of a choir conductor. As a conductor sets the tone and tempo to combine different voices of the choir into a harmonious song, BMS tunes the current and voltage of each cell like a conductor.

BMS performs three main functions: monitoring, cell management, and control. Monitoring involves observing voltage, current, temperature, etc., through sensors in the battery system, and predicting state of charge (SoC) and the state of health (SoH) of the battery based on the data. Cell management refers to cell balancing, which reduces the voltage differences between battery cells to enhance energy efficiency and charging rate. Control is the process of regulating to prevent overcharging, overdischarging, and overcurrent in the battery. Ultimately, BMS plays a role in managing the life, performance, and safety of the battery, and as batteries continue to develop, BMS is also becoming more sophisticated and continues to evolve.

"C-rate" is a term one needs to know when dealing with fast charging speeds to the extent of acquiring special chargers and cables capable of rapid charging. Abbreviated from "current rate", the C-rate is a measure of the rate at which a battery is charged or discharged. It is also called "charge and discharge rates" and uses "C" as the unit, which is the abbreviation of "capacity". C-rate can be calculated by dividing the charging or discharging current (A) by the rated battery capacity (Ah). The standard C-rate is generally 1C.

Understanding the C-rate is very helpful when using batteries. First, the charge C-rates help users estimate how long it will take to fully charge their batteries. For example, when one sees a battery label that states, "Chargeable at 10C," it means the battery can be charged at a current of 10 times the battery capacity, and it takes at least 6 minutes to be completely charged.

On the other hand, the discharge C-rates help users predict the limits of product performance. For instance, a drone battery with a high discharge C-rate indicates a faster discharge rate, meaning it can perform complex maneuvers that require sudden high currents. Conversely, a low discharge C-rate could mean difficulty in performing high-performance actions that require high currents. Let us suppose that there is a drone battery with a discharge C-rate of 100C. The battery can supply a current of up to 100 times its capacity, but if the drone continues the move that requires that much power, it is discharged 100 times faster than the standard of an hour (3,600 seconds). Accordingly, it is discharged in just 36 seconds. As the use of batteries in our daily lives increases, and more products require fast charging or a sudden rush of high current, understanding the concept of C-rate will help us choose the right battery for each electronic device.

When we use portable electronic devices, we always check the battery's charge status. For instance, the battery icon on a phone shows percentages like 100%, 50%, 20%, etc. This indicator, showing how much percentage of the battery is left, is known as "SoC". Soc stands for "State of Charge". It represents the remaining battery capacity in percentage(%) which is the current usable battery capacity divided by the total capacity.

Accurate SoC measurement is a core competitive aspect for battery manufacturers. As such, there are various methods to measure SoC, including chemical, voltage, current integration, and pressure measurement methods. SoC is an element to provide convenience to users. Through SoC measurements, it is possible to determine how much longer the battery can be used more and users can determine when to charge and end the battery themselves, allowing them to use the device more efficiently. From the manufacturer's perspective, SoC is considered very important as it can enhance the stability of the battery. By setting the maximum charge of the battery lower than the highest point of the SoC and the minimum charge of the battery higher than the lowest point of the SoC, various problems such as safety issues due to overcharging and over-discharging of the battery can be prevented in advance. As a result, a more stable battery usage environment can be provided to users.

Batteries, like all other products, have a lifespan. The SoH (State of Health) is a useful indicator for the remaining life and the current state of batteries. It shows the battery's condition compared to its initial conditions at a glance. One can easily check the SoH on some smartphones, tablets, or laptops. Devices that do not provide SoH information, such as "maximum battery performance", can be assessed through specialized testing equipment. However, SoHs can vary even among batteries that have been used for the same period because battery life is affected by many factors, including user habits and the environment. In particular, if the electric vehicle battery is well managed, it is possible to drive the vehicle for 2 to 3 times longer than the manufacturer's warranty period with little decrease in SoH. SoH is referred to as "Maximum capacity" on some devices.

Recently, with many second-hand transactions taking place in real life, transactions of IT devices with batteries, such as smartphones and tablet PCs, are also increasing. At this time, SoH is a factor that must be checked to trade better products. Not only a second-hand transaction, but also an IT device with a built-in battery can be used more efficiently if the health status of the battery is checked with the SoH.

A cell is the basic unit of a battery. In devices requiring a lot of power, like electric vehicles, a battery pack contains numerous cells. However, even identical cells may develop voltage differences due to manufacturing processes or external factors. For example, when two cells connected in series are charged, the first cell could reach 4.2 V while the second cell stops at 4.0 V. Such imbalances between cells can affect battery capacity and life, and significantly increase the risk of safety issues due to overcharging and over-discharging. To prevent this, "cell balancing" is necessary.

Cell balancing adjusts and aligns the voltage differences between serially connected battery cells. It can be of two types: passive and active. Passive cell balancing dissipates the charging energy of a cell through a resistance to lower the cell voltage. In other words, it removes the charge from cells with more capacity by dissipating heat, making the charge of all cells uniform. While this method is simple and cost-effective, it is less energy-efficient as it wastes excess voltage and can only be applied during charging.

Active cell balancing transfers the charging energy from cells with higher voltage to those with lower voltage. It redistributes the charge to equalize the voltage between cells by providing more capacity to cells with less capacity. Unlike passive cell balancing, which dissipates heat, active balancing redistributes energy, making it more energy-efficient and faster in charging. While active cell balancing can be applied during both charging and discharging, it involves more complex additional circuitry and is thus more costly. Cell balancing happens in the BMS (Battery Management System), where the CMU (Cell Monitoring Unit) in the BMS measures the state of the cells and starts balancing, enabling safer use of the battery.

One or more embodiments may provide an advanced real time ensemble inverter-interfaced AI framework for power transformer health assessment and prognostics in BESS. The system may utilize an indirect-measurement hybrid deep learning architecture for power transformer health assessment. The framework may process inverter-side parameters, IMD and Grid Side data to monitor insulation health, thermal and electrical stress patterns. This methodology may enable early fault detection and health prognostics using existing inverter & grid-side measurements, providing a cost-effective transformer monitoring solution for BESS applications.

One or more embodiments may solve problems where current solutions miss early-stage degradation patterns. Component failures may often be detected too late, leading to severe system downtime. With an MVT's lead time of approximately 365 days (avg.), a failure may significantly impact site operations. Maintenance may typically be reactive rather than predictive. Existing methods may need specialized equipment installation.

The system may provide indirect monitoring where the system may use inverter-side parameters for transformer health. The system may provide correlation between inverter behavior and transformer stress. The system may provide cost-effective monitoring without direct transformer sensors. One or more embodiments may provide comprehensive health assessment that may cover insulation degradation, thermal stress, electrical stress, and other conditions.

One or more embodiments may provide a field deployable solution for transformer health monitoring in BESS. The system may use existing measurements with no additional sensors needed. The system may handle real-world operating conditions and variations. The system may work with standard inverter control systems. The system may adapt to different transformer sizes and configurations.

One or more embodiments may use sample data from the PCS Modbus including one or more of inverter/PCS data such as DC bus voltage which may be voltage between DC positive and DC negative, DC current of power stack 1, DC current of power stack 2, DC current of power stack 3, DC voltage of power stack 1, DC voltage of power stack 2, DC voltage of power stack 3, total AC current of Phase 1, total AC current of Phase 2, total AC current of Phase 3, power factor, total apparent power, total active power, total reactive power, line to line voltage L1-L2, line to line voltage L2-L3, line to line voltage L3-L1, grid frequency, DC+ to GND voltage, DC- to GND voltage, and IMD/IR. Grid side data may include grid voltage L1-L2, grid voltage L2-L3, grid voltage L3-L1, total AC grid of Phase 1, total AC current of Phase 2, total AC current of Phase 3, total apparent power, total active power, or total reactive power.

The system may provide winding predictive analytics through an algorithm (e.g., WIND (Winding Intelligence & Degradation Detection)). The algorithm may analyze parameters including current imbalance ratios and PF variations. The system may perform correlation analysis including primary-secondary relationships, cross-phase patterns, and load impact assessment. The system may provide temporal tracking including long-term trends, pattern recognition, and anomaly detection. The system may analyze load response including load-dependent behavior, efficiency tracking, and daily statistics collection. The system may create a Winding Health Index (WHI) percentage using the parameters, correlation analysis, temporal tracking, and load response. The system may provide real-time execution.

One or more embodiments may provide tap changer (TC) predictive analytics through an algorithm (e.g., TAPE (Tap-changer Analytics & Performance Evaluation)). The system may perform contact analysis including resistance tracking, arcing signatures, and voltage deviations. The system may analyze current responses including current deviations, load impact, and balance tracking. The system may evaluate performance metrics including efficiency, response time, and daily statistics collection. The system may create a TC Health Index (TCHI) percentage using contact analysis, current response, and performance metrics. The system may provide real-time execution.

Additional predictive analytics algorithms may include core issue analysis, overfluxing, DC bias, indirect cooling assessment, and correlating grid events. The system may analyze voltage sag, voltage swell, under frequency, over frequency, poor power quality, and ground faults. Each algorithm may operate independently but may contribute to a unified system health assessment. One or more embodiments may provide advanced transformer learning for algorithmic system-health through AI/ML. The system may include an input layer with algorithm outputs including WIND (Winding Analytics), TAPE (Tape Changer Analytics), core issue analysis, overfluxing, DC bias, indirect cooling assessment, grid side correlation, ground faults, and efficiency tracking. The system may include a transformer encoder layer with multi-head attention, algorithm-specific attention weights, cross-algorithm pattern recognition, and temporal relationship learning. The system may provide pattern recognition including fault signature identification, anomaly detection, and system behavior learning. The system may provide cross-algorithm learning including inter-algorithm correlations and cascading effect analysis.

One or more embodiments may provide an output layer with system intelligence including health assessment with overall system health index, component-specific health scores, and risk level classification. The system may provide predictive analytics including early fault warnings, failure progression prediction, and time-to-maintenance estimation. The system may provide action recommendations including maintenance scheduling, preventive actions, and operation optimization. The system may provide real-time processing features including 1-minute execution cycle, dynamic threshold adjustment, continuous learning capability, adaptive response system, and system-wide pattern detection.

The system may provide smart health monitoring for grid connected PCS, MVT & batteries that may avoid unplanned outages/downtime, save lost revenue due to downtime, save LD (liquidated damages), and reduce maintenance/service costs through predictive scheduling. For MVT, the system may eliminate need for expensive direct monitoring equipment and may reduce maintenance expenses. The system may provide operational improvements including improved system reliability and predictive maintenance capability.

One or more embodiments may provide improvements to the functioning of hardware components within battery energy storage systems through predictive analytics and indirect monitoring capabilities. The system may enhance the operational effectiveness of medium voltage transformers by utilizing existing inverter and grid-side measurements to assess transformer health without requiring additional specialized monitoring equipment. One or more algorithms may reduce hardware stress on transformers by providing early detection of degradation patterns that could lead to thermal, electrical, or mechanical stress conditions. Through a WIND (Winding Intelligence & Degradation Detection) algorithm, the system may identify current imbalance ratios, power factor variations, and load-dependent behaviors that indicate developing stress conditions within transformer windings. By detecting these conditions early, the system may enable preventive maintenance actions that reduce cumulative stress on transformer components.

The system may improve the lifetime and reliability of transformers by providing predictive maintenance capabilities that prevent unexpected failures. The system may generate winding health index (WHI) percentages and tap changer health index (TCHI) percentages that enable maintenance scheduling based on actual component condition rather than fixed time intervals. This approach may extend transformer operational life by addressing degradation before it progresses to failure conditions. The software may enable transformers to operate more safely within their design parameters by providing continuous monitoring of operational conditions. The system may detect overfluxing conditions, DC bias effects, and core issues that could cause transformers to operate outside safe operating limits. By providing real-time alerts when these conditions are detected, the system may prevent damage that could result from continued operation under adverse conditions.

One or more embodiments may reduce energy consumption by eliminating the need for continuous operation of specialized transformer monitoring equipment. The system may activate monitoring functions only when needed, providing an energy-efficient approach to transformer health assessment. Additionally, by optimizing transformer operation through health-based maintenance, the system may improve overall system efficiency and reduce energy losses. The software may reduce costs by enabling transformer health monitoring without requiring expensive direct monitoring equipment installation. Traditional transformer monitoring solutions may require specialized sensors, ambient condition monitoring equipment, and dedicated communication systems. The disclosed system may achieve similar monitoring capabilities using existing inverter and grid measurements, potentially reducing capital expenditure for monitoring infrastructure.

One or more embodiments may improve BMS controller functioning by providing enhanced predictive capabilities for system-wide health assessment. The transformer encoder layer architecture may enable efficient processing of multiple algorithm outputs through multi-head attention mechanisms and cross-algorithm pattern recognition. This approach may reduce computational overhead compared to running separate analysis algorithms independently.

The system may reduce computational latency through its 1-minute execution cycle design and real-time processing capabilities. The machine learning model may be optimized for rapid inference, enabling timely detection of developing fault conditions. The system may also support distributed processing across multiple controllers through its modular algorithm architecture, where different health assessment algorithms may operate on separate processing units.

The software may increase fault tolerance by providing multiple independent assessment pathways through various algorithms (e.g., WIND, TAPE (Tap-changer Analytics & Performance Evaluation)), core issue analysis, and grid event correlation. If one assessment pathway experiences issues, other algorithms may continue to provide health monitoring capabilities, improving overall system reliability. For measurement and accuracy improvements, the machine learning model may enhance the accuracy of transformer health assessment by correlating multiple data sources and identifying patterns that may not be apparent through individual parameter monitoring. The system may compensate for measurement variations and sensor drift by analyzing trends across multiple parameters and time periods.

One or more embodiments may improve resolution and precision of transformer health assessment without requiring additional sensors by extracting more information from existing measurements. Through temporal tracking and pattern recognition capabilities, the system may detect subtle changes in transformer behavior that indicate developing issues before they become apparent through traditional monitoring methods. The system may provide earlier and more accurate fault detection for transformer-related issues including insulation degradation, thermal stress, electrical stress, and tap changer problems. The machine learning model may identify fault signatures and anomaly patterns that precede actual component failures, enabling proactive maintenance interventions.

The system may improve overall BESS efficiency by optimizing transformer operation through predictive maintenance. By preventing unexpected transformer failures, the system may maintain consistent power conversion efficiency and reduce system downtime. The health monitoring capabilities may enable more efficient maintenance scheduling, reducing the frequency of unnecessary maintenance activities while ensuring timely intervention when needed. The system may extend the operational life of transformers by enabling condition-based maintenance rather than time-based maintenance schedules. By monitoring actual component health rather than relying on conservative maintenance intervals, the system may allow transformers to operate longer while maintaining safety and reliability standards.

One or more embodiments may improve safety under extreme operating conditions by providing continuous monitoring of transformer stress indicators. During grid frequency events, voltage fluctuations, or high-load conditions, the system may assess transformer response and provide alerts if operating conditions exceed safe thresholds.

The system may provide technical contributions without additional hardware and the software may improve modeling and simulation of transformer performance by providing real-world operational data and health trends. The machine learning model may enhance predictions of transformer degradation patterns and failure modes, supporting better maintenance planning and replacement scheduling.

The system may improve interoperability with other BESS components by providing standardized health assessment outputs that may be integrated with energy management systems, power plant controllers, and utility control systems. The health monitoring data may support grid-level decision making and optimize overall system performance. The software may enhance cybersecurity and communication robustness by utilizing existing communication pathways rather than requiring additional monitoring networks. The system may reduce data transmission requirements by processing raw measurements locally and transmitting only health assessment results and alerts.

The diagnostic capabilities provided by the machine learning model may improve usability for maintenance engineers by providing clear health indices, predictive analytics, and action recommendations. The system may enable faster root cause analysis by correlating multiple operational parameters and identifying specific degradation patterns associated with different failure modes.

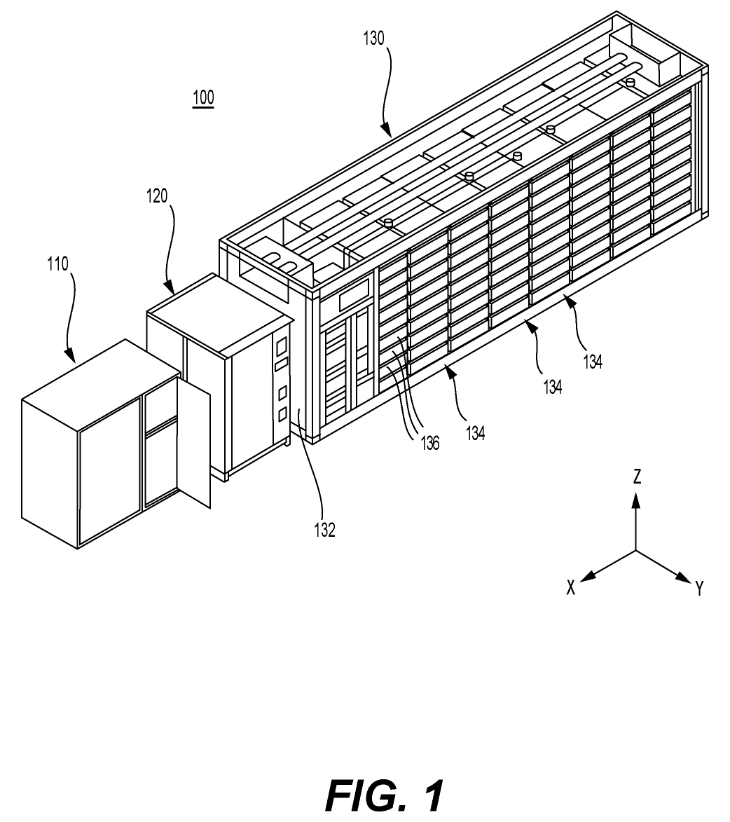

FIG. 1 depicts an exemplary battery system infrastructure, according to one or more embodiments. Battery energy storage system 100 may include battery control 110, battery thermal protection 120, and battery array 130. Battery array 130 may include housing 132 and battery rack 134 (e.g., one or more battery racks, eight battery racks).

Housing 132 may be a battery frame, for example. Battery rack 134 may include battery module 136 (e.g., one or more battery modules, nine battery modules). Battery module 136 may include one or more battery cells in a module case. Battery module 136 may be stacked in a direction, for example, in a vertical direction as battery rack 134. Battery rack 134 may include a rack case to facilitate stacking the battery module 136. Each battery module 136 may be received in a receiving space of the rack case as a module stack. One module stack may constitute one of battery rack 134. Alternatively, two or more module stacks may constitute one of battery rack 134.

Battery module 136 included in the battery rack 134 may further include a control unit such as a battery management system (BMS) for each battery module or each predetermined group. For example, each battery module 136 may include a pack BMS. A battery module 136 including a pack BMS may be referred to as a battery pack. For example, the battery rack 134 may include a plurality of battery packs. Alternatively, a battery pack assembly may include one or more battery cells with a module-less design, such as a direct cell-to-pack design, for example.

The battery rack 134 may be arranged in at least one direction, for example, a horizontal direction. For example, battery array 130 may include eight battery racks of battery rack 134 that may be arranged in the left-right direction (X-axis direction) in battery array 130. Each battery rack 134 may have a control unit, for example, a rack BMS. The rack BMS may be connected to the plurality of pack BMSs included in battery rack 134 to transmit and receive data to and from the plurality of pack BMSs and control them.

The rack BMS may be connected to a control device, for example, battery control 110. Battery rack 134 may include an integrated control unit such as, for example, a battery processing unit (BPU) which may perform communications or control operations with the plurality of rack BMSs.

Housing 132 may be a container housing. Housing 132 may have an empty internal space. Housing 132 may accommodate the battery rack 134 in the internal space. More specifically, as depicted in FIG. 1, housing 132 may be formed in the shape of an approximately rectangular prism. Housing 132 may include an upper housing, a lower housing, a front housing, a rear housing, a left housing, and a right housing with respect to the internal space. Housing 132 may accommodate the battery rack 134 in the internal space defined by these six unit housings.

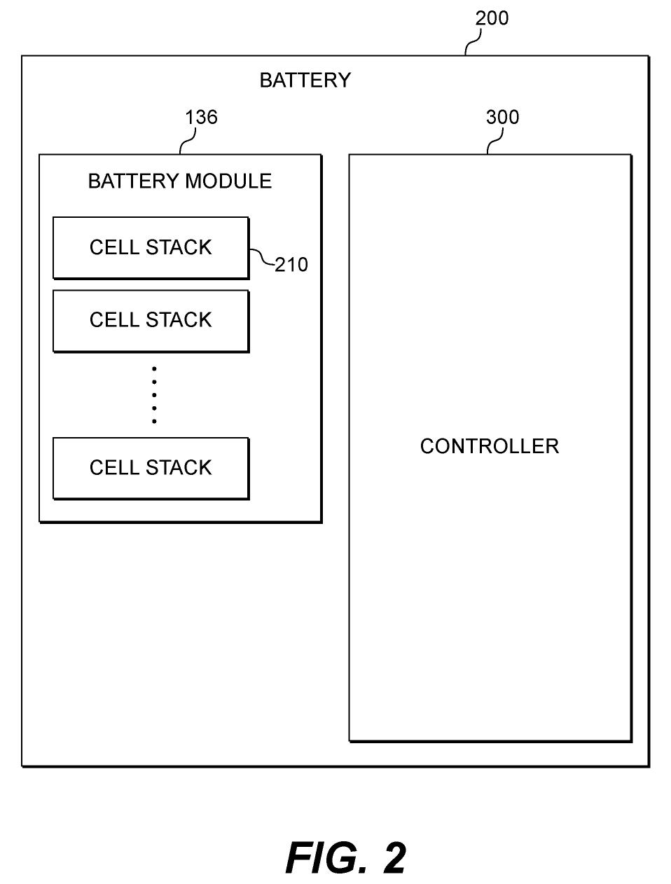

FIG. 2 depicts a battery, according to one or more embodiments. Battery 200 may include a battery module 136 and controller 300. Battery module 136 may include a plurality of cell stacks, including cell stack 210.

Battery 200 may include a battery pack. Battery 200 may include an overcharge prevention apparatus. Overcharge prevention apparatus may include a voltage measuring unit, a current regulating unit, a controller 300, and optionally may further include at least one of a disconnecting unit, a current measuring unit, and a cooling unit. Additionally, when the overcharge prevention apparatus includes a disconnecting unit, a discharge inducing unit may be included.

The plurality of cell stacks, which may include cell stack 210, may be connected in series and installed on a high current path between two power terminals of battery 200. A voltage measuring unit may measure the voltage of each cell stack 210, and may generate a first monitoring signal indicating the measured voltage. The first monitoring signal generated by the voltage measuring unit may be transmitted to the controller. The current regulating unit may be configured to selectively provide each cell stack 210 with bypass paths connected in parallel. Current regulating unit may provide bypass paths individually to the plurality of cell stacks, which may include for example cell stack 210.

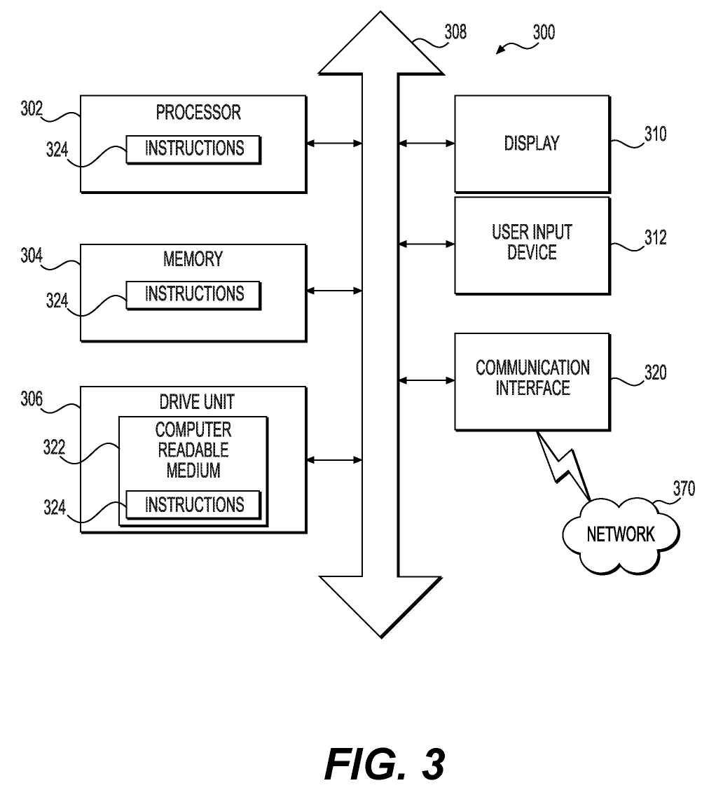

FIG. 3 depicts a controller, according to one or more embodiments. FIG. 3 and the following discussion provide a brief, general description of a suitable computing environment in which the present disclosure may be implemented. In one embodiment, any of the disclosed systems, methods, and/or graphical user interfaces may be executed by or implemented by a computing system consistent with or similar to that depicted in FIG. 3. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

The controller 300 may include a set of instructions that can be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code, and the like, operating alone or in combination. Likewise, processing strategies may include multiprocessing, multitasking, parallel processing, and the like.

As shown, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of the instructions 324, e.g., software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is shown to be a single medium, the term "computer-readable medium" may include a single medium or multiple media, such as a centralized or distributed database, and/or associated caches and servers that store one or more sets of instructions. The term "computer-readable medium" may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

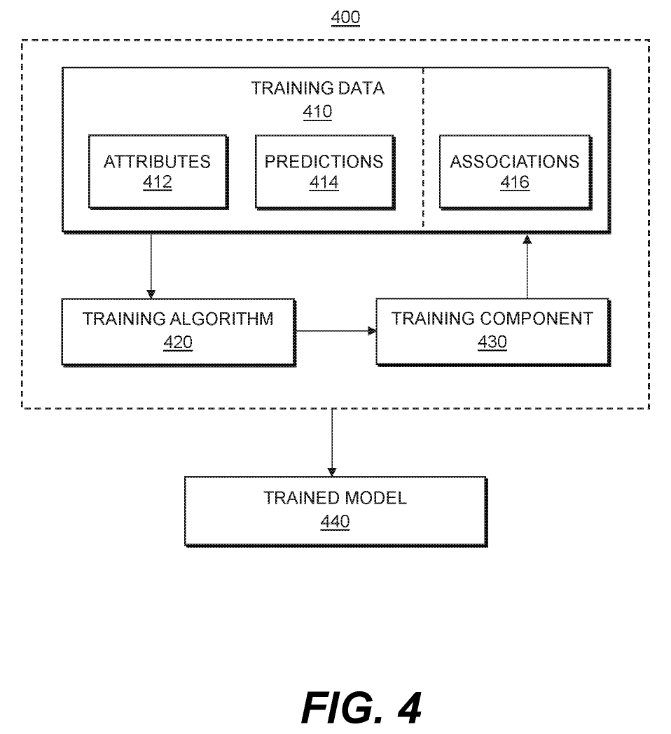

FIG. 4 depicts a flow diagram for training a machine learning model, according to one or more embodiments. As disclosed herein, one or more implementations disclosed herein may be applied by using a machine learning model. A machine learning model as disclosed herein may be trained using one or more components or operations. As depicted in flow diagram 400 of FIG. 4, training data 410 may include one or more of attributes 412 and predictions 414 related to a machine learning model to be trained. The attributes 412 may be from any applicable source including a component, attribute of a component, extracted feature, or set shown in the figures provided herein. The predictions 414 may be included for machine learning models generated based on supervised or semi-supervised training. An unsupervised machine learning model might not be trained using predictions 414. Predictions 414 may include known or desired outputs for future inputs similar to or in the same category as attributes 412 that do not have corresponding known outputs.

The training data 410 and a training algorithm 420 may be provided to a training component 430 that may apply the training data 410 to the training algorithm 420 to generate a trained machine learning model 440. The training component 430 may be provided associations 416 that compare a previous output of the corresponding machine learning model to apply the previous result to re-train the machine learning model. The associations 416 may be used by the training component 430 to update the corresponding machine learning model. The training algorithm 420 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. One or more machine learning models disclosed herein may continuously update based on feedback associated with use or implementation of the machine learning model outputs.

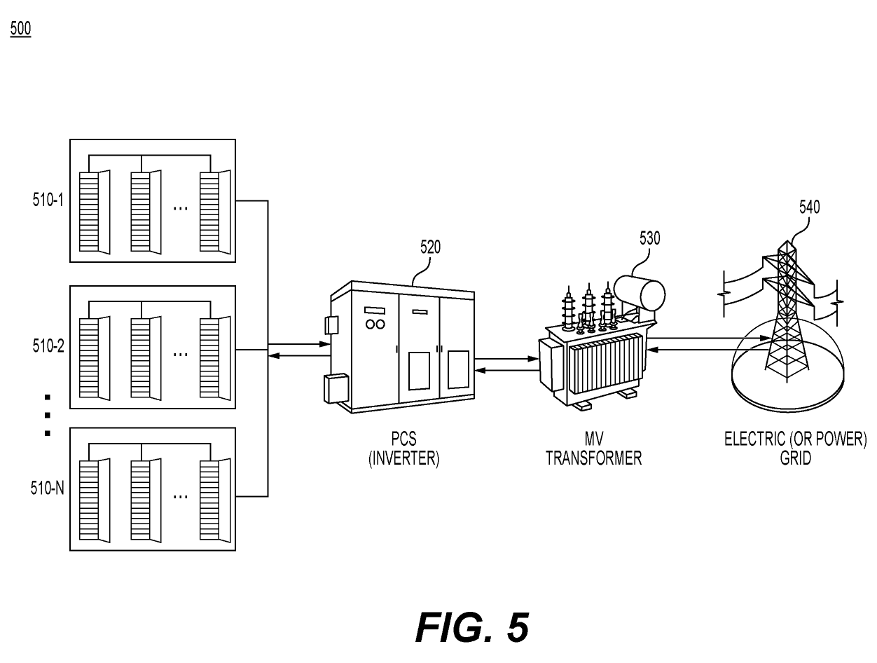

FIG. 5 depicts a battery energy storage and power conversion system infrastructure, according to one or more embodiments. The system 500 may include a plurality of batteries connected to an inverter 520, which may be connected to a transformer 530 that interfaces with an electric grid 540. The plurality of batteries may include a first battery 510-1, a second battery 510-2, and a nth battery 510-N, where N may represent any number of batteries that may be included in the system 500. The batteries may be arranged in series, parallel, or a combination thereof to provide electrical energy storage and delivery capabilities for the system 500.

The first battery 510-1, the second battery 510-2, and the nth battery 510-N may be connected to the inverter 520 to enable DC-AC power conversion functionality. The inverter 520 may function as a power conversion system that converts direct current from the batteries to alternating current for grid connection. The inverter 520 may also convert alternating current from the electric grid 540 to direct current for charging the batteries during energy storage operations. The inverter 520 may include multiple power stacks that process electrical power from different battery groups or sections within the system 500.

The inverter 520 may be connected to the transformer 530, which may provide voltage transformation capabilities to interface with the electric grid 540. The transformer 530 may be a medium voltage transformer that steps up or steps down voltage levels as needed for proper connection to the electric grid 540. The transformer 530 may facilitate power transfer between the inverter 520 and the electric grid 540 while providing electrical isolation and voltage matching functions.

The system 500 may implement an indirect monitoring approach where operational data may be gathered from the inverter 520 and the electric grid 540 to assess the health of the transformer 530 without requiring direct transformer sensors. This approach may eliminate the need for specialized equipment installation directly on the transformer 530, providing a cost-effective monitoring solution. The system 500 may utilize existing measurements from the inverter 520 including one or more of DC bus voltage measurements, DC current measurements from multiple power stacks, AC current measurements for each phase, power factor values, apparent power measurements, active power measurements, reactive power measurements, line-to-line voltage measurements, grid frequency measurements, or insulation monitoring device readings.

The system 500 may collect grid-side data from the electric grid 540 including one or more of grid voltage measurements for each phase combination, total AC current measurements for each phase, and power measurements including apparent power, active power, or reactive power from the grid side of the transformer 530. The combination of inverter-side parameters and grid-side data may enable the system 500 to monitor insulation health, thermal stress patterns, and electrical stress conditions within the transformer 530 through indirect measurement techniques.

The system 500 may operate as a field deployable solution that works with standard inverter control systems and may adapt to different transformer sizes and configurations. The system 500 may handle real-world operating conditions and variations without requiring modifications to existing hardware infrastructure. The indirect monitoring capabilities may provide early fault detection and health prognostics using existing inverter and grid-side measurements, enabling predictive maintenance approaches rather than reactive maintenance strategies.

The system 500 may process the operational data through machine learning algorithms to identify patterns and correlations between inverter behavior and transformer stress conditions. The system 500 may generate health assessments and predictive analytics based on the analysis of the operational data collected from the inverter 520 and the electric grid 540. The system 500 may provide notifications and control actions based on the health assessment results to optimize transformer operation and prevent potential failures.

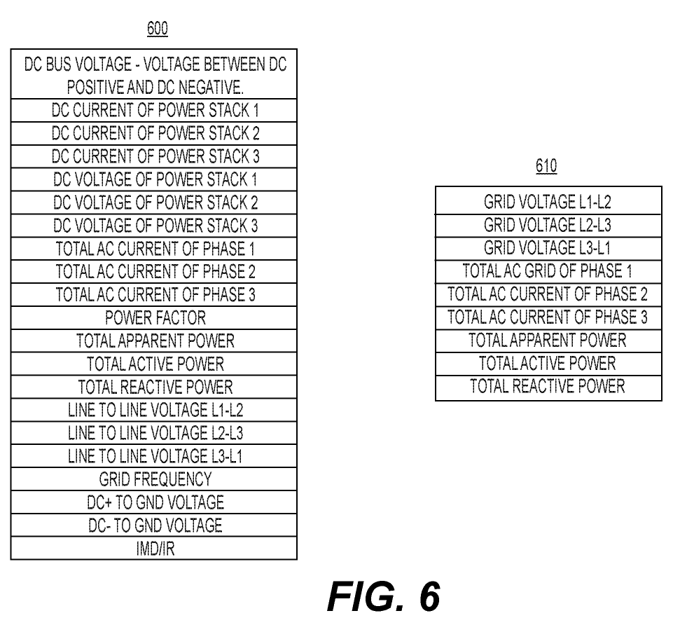

FIG. 6 depicts tables with sample data parameters from a power conversion system, according to one or more embodiments. Table 600 and table 610 may present one or more operational data parameters collected from the power conversion system and grid components of the system 500. Table 600 may display inverter-side measurements that may be gathered from the inverter 520 through existing monitoring capabilities without requiring additional specialized equipment installation on the transformer 530.

Table 600 may include DC bus voltage measurements that may represent the voltage differential between DC positive and DC negative terminals within the inverter 520. The DC bus voltage may provide an indication of the electrical stress conditions experienced by the transformer 530 during power conversion operations. Table 600 may further include DC current measurements from multiple power stacks, including DC current of power stack 1, DC current of power stack 2, and DC current of power stack 3, which may enable assessment of load distribution and current imbalance conditions that may affect transformer winding stress patterns.

Table 600 may present DC voltage measurements corresponding to each power stack, including DC voltage of power stack 1, DC voltage of power stack 2, and DC voltage of power stack 3. These voltage measurements may provide data for analyzing power stack performance variations that may correlate with transformer loading conditions. The table 600 may include AC current measurements for each phase, including total AC current of phase 1, total AC current of phase 2, and total AC current of phase 3, which may enable detection of phase imbalances that may indicate developing transformer winding issues.

Power measurements within table 600 may include one or more of power factor values, total apparent power, total active power, or total reactive power. The power factor values may provide indicators of power quality conditions that may affect transformer efficiency and thermal stress. The apparent power, active power, or reactive power measurements may enable determination of transformer loading conditions and efficiency metrics without direct transformer monitoring. The table 600 may include line-to-line voltage measurements, including line to line voltage L1-L2, line to line voltage L2-L3, and line to line voltage L3-L1, which may provide data for assessing voltage balance and harmonic distortion effects on the transformer 530.

Table 600 may present grid frequency measurements and grounding voltage measurements, including DC+ to GND voltage and DC- to GND voltage. The grid frequency measurements may enable detection of frequency variations that may cause overfluxing conditions within the transformer 530. Table 600 may include insulation monitoring device readings (IMD/IR) that may provide direct assessment of insulation resistance conditions within the system 500, which may correlate with transformer insulation health.

Table 610 may display grid-side data parameters collected from the electric grid 540 connection point. Table 610 may include one or more of grid voltage measurements for each phase combination, including grid voltage L1-L2, grid voltage L2-L3, or grid voltage L3-L1. These grid voltage measurements may enable assessment of voltage stability conditions and grid events that may affect transformer stress patterns, including voltage sag and voltage swell conditions.

Table 610 may present grid current measurements including one or more of total AC current of phase 1, total AC current of phase 2, or total AC current of phase 3 from the grid side of the transformer 530. These current measurements may provide data for analyzing load response characteristics and current balance conditions that may indicate transformer tap changer performance or winding degradation. Table 610 may include power measurements from the grid side, including one or more of total apparent power, total active power, or total reactive power. These power measurements may enable determination of transformer efficiency and loss characteristics through comparison with inverter-side power measurements.

The operational parameters presented in table 600 and table 610 may enable indirect transformer health assessment by providing measurable indicators of transformer stress without requiring specialized monitoring equipment installation directly on the transformer 530. The DC bus voltage measurements, DC current measurements from multiple power stacks, AC current measurements for each phase, power factor values, apparent power measurements, active power measurements, reactive power measurements, line-to-line voltage measurements, grid frequency measurements, and insulation monitoring device readings may collectively provide a data set for machine learning analysis of transformer health conditions.

The combination of inverter-side and grid-side measurements may enable detection of transformer performance degradation through analysis of power transfer efficiency, voltage regulation characteristics, and current balance patterns. The operational parameters may provide early indicators of insulation degradation, thermal stress conditions, and electrical stress patterns within the transformer 530 by correlating changes in power quality metrics with transformer loading conditions and environmental factors. The data parameters may support predictive maintenance approaches by enabling trend analysis and anomaly detection without the cost and complexity of direct transformer monitoring systems.

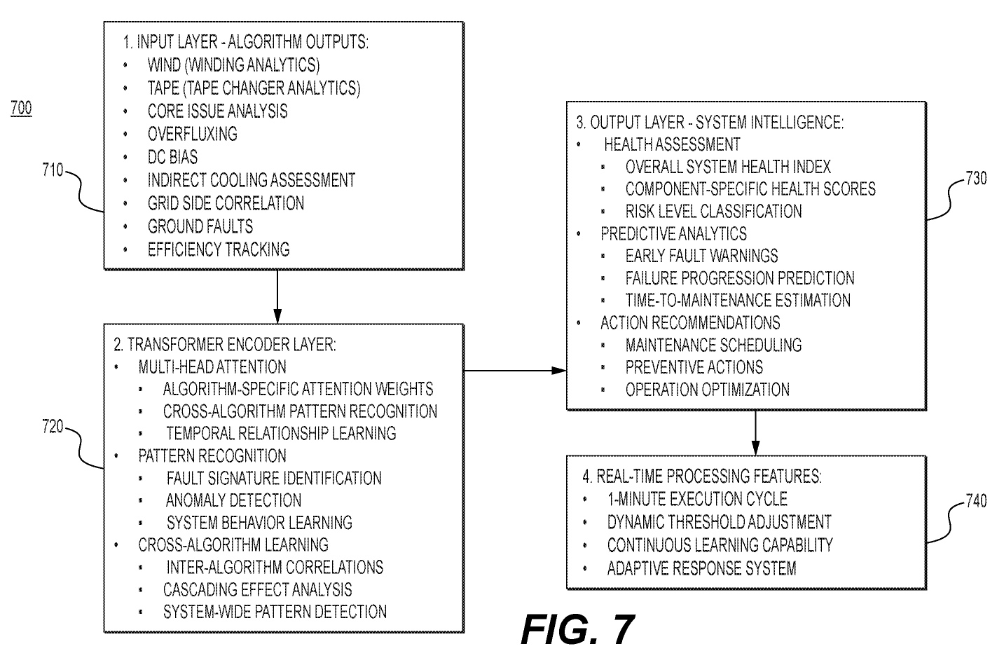

FIG. 7 depicts an exemplary flow diagram for a health monitoring and control system, according to one or more embodiments. The flow diagram 700 may illustrate a machine learning architecture that processes multiple analytical inputs to generate comprehensive transformer health assessments. The flow diagram 700 may include an input layer 710, a transformer encoder layer 720, an output layer 730, and real-time processing 740 features that work together to provide predictive analytics for transformer monitoring in battery energy storage systems.

The input layer 710 may receive algorithm outputs from multiple analytical pathways that process operational data from the inverter 520 and the electric grid 540. The input layer 710 may include WIND (Winding Analytics) algorithm outputs that provide winding intelligence and degradation detection capabilities through analysis of current imbalance ratios, power factor variations, primary-secondary relationships, cross-phase patterns, load impact assessment, long-term trends, pattern recognition, and anomaly detection. The input layer 710 may receive TAPE (Tap Changer Analytics) algorithm outputs that provide tap-changer analytics and performance evaluation through contact analysis, resistance tracking, arcing signatures, voltage deviations, current response analysis, and performance metrics evaluation.

The input layer 710 may process core issue analysis outputs that assess transformer core conditions through magnetic flux analysis and core loss evaluation. The input layer 710 may receive overfluxing analysis outputs that detect conditions where the transformer 530 may operate beyond its designed flux density limits due to voltage or frequency variations. The input layer 710 may include DC bias analysis outputs that identify direct current components in the transformer 530 that may cause core saturation and increased losses.

The input layer 710 may process indirect cooling assessment outputs that evaluate thermal management effectiveness through analysis of temperature-related operational parameters. The input layer 710 may receive grid side correlation outputs that analyze grid events including voltage sag, voltage swell, underfrequency conditions, over frequency conditions, and power quality variations that may affect transformer stress patterns. The input layer 710 may include ground fault analysis outputs that detect insulation failures and grounding system issues. The input layer 710 may process efficiency tracking outputs that monitor transformer performance degradation through power transfer efficiency determinations.

The transformer encoder layer 720 may process the algorithm outputs from the input layer 710 through advanced machine learning techniques. The transformer encoder layer 720 may implement multi-head attention mechanisms that assign algorithm-specific attention weights to different analytical inputs based on their relevance to current operating conditions. The multi-head attention mechanisms may enable the transformer encoder layer 720 to focus computational resources on the most significant analytical pathways while maintaining awareness of all input parameters.

The transformer encoder layer 720 may perform cross-algorithm pattern recognition that identifies relationships between different analytical components through cascading effect analysis and inter-algorithm correlations. The cascading effect analysis may detect how degradation in one transformer component may influence the performance of other components, enabling prediction of failure progression patterns. The inter-algorithm correlations may identify relationships between different health assessment algorithms that may indicate developing fault conditions before individual algorithms reach threshold levels.

The transformer encoder layer 720 may implement temporal relationship learning that analyzes patterns across time periods to identify long-term degradation trends and seasonal variations in transformer performance. The temporal relationship learning may enable the transformer encoder layer 720 to distinguish between normal operational variations and developing fault conditions by analyzing historical patterns and current operational data.

The output layer 730 may generate system intelligence outputs based on the processed information from the transformer encoder layer 720. The output layer 730 may produce health assessments that include an overall system health index representing the comprehensive condition of the transformer 530. The output layer 730 may generate component-specific health scores associated with each of the components of the inverter 520 and transformer 530, enabling targeted maintenance planning and fault isolation.

The output layer 730 may provide predictive analytics including time-to-maintenance estimation that determines the remaining operational time before maintenance intervention may be needed based on current degradation rates and operational stress patterns. The output layer 730 may generate failure progression prediction that forecasts how identified degradation patterns may develop over time, enabling proactive maintenance scheduling. The output layer 730 may produce early fault warnings with failure progression prediction that alert operators to developing conditions before they progress to failure states.

The output layer 730 may generate action recommendations including maintenance scheduling suggestions, preventive actions to mitigate identified stress conditions, and operation optimization recommendations to reduce transformer stress while maintaining system performance. The output layer 730 may provide risk level classification that categorizes the severity of identified conditions and prioritizes maintenance activities based on potential impact to system operation.

The real-time processing 740 features may enable continuous monitoring and analysis capabilities through approximately one minute execution cycles that provide real-time assessment of transformer health conditions. The real-time processing 740 may implement dynamic threshold adjustment capabilities that adapt threshold values based on current operating conditions, seasonal variations, and historical performance patterns. The dynamic threshold adjustments may prevent false alarms during normal operational variations while maintaining sensitivity to developing fault conditions.

The real-time processing 740 may include continuous learning capability that updates the machine learning model based on operational experience and maintenance outcomes. For example, when a transformer 530 undergoes scheduled maintenance and inspection reveals specific degradation patterns that correlate with previously identified anomalies in the operational data, the machine learning model may incorporate this feedback to improve future predictions. The system may adjust algorithm weights and threshold values based on confirmed maintenance findings, such as when actual winding insulation measurements validate predicted degradation trends from the WIND algorithm, thereby enhancing the accuracy of subsequent health assessments. The continuous learning capability may improve prediction accuracy over time by incorporating feedback from actual maintenance activities and component performance history. The real-time processing 740 may provide an adaptive response system that adjusts monitoring sensitivity and alert thresholds based on current system conditions and operational priorities.

The real-time processing 740 may implement system-wide pattern detection that identifies correlations between multiple system components and operational parameters. The system-wide pattern detection may enable early identification of developing issues that may affect multiple components or system-level performance characteristics.

The architecture represented by the flow diagram 700 may provide improvements over prior transformer monitoring systems by integrating multiple analytical pathways into a unified predictive framework. Traditional transformer monitoring approaches may rely on individual parameter monitoring or single-algorithm analysis that may miss complex interactions between different degradation mechanisms. The flow diagram 700 may enable comprehensive assessment through simultaneous analysis of winding conditions, tap changer performance, core issues, thermal management, and grid interaction effects.

The machine learning architecture may eliminate the need for specialized transformer monitoring equipment by utilizing existing inverter 520 and grid measurements to assess transformer 530 health conditions. The unified predictive framework may provide more accurate fault detection and health assessment compared to individual monitoring approaches by correlating multiple analytical pathways and identifying patterns that may not be apparent through single-parameter analysis. The real-time processing 740 capabilities may enable immediate response to developing conditions while the continuous learning features may improve system performance over time through operational experience integration.

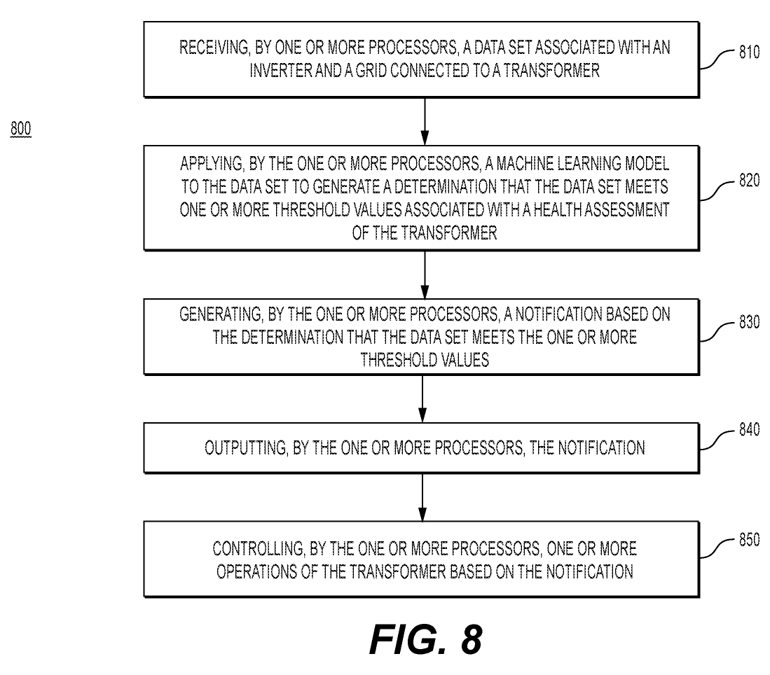

FIG. 8 depicts an exemplary flow diagram for a health monitoring and control process, according to one or more embodiments. The method 800 may provide a systematic approach for processing operational data from the inverter 520 and the electric grid 540 to generate actionable health assessments and control decisions for the transformer 530.

The method 800 may begin with an operation 810 where one or more processors receive a data set associated with the inverter 520 and the electric grid 540 connected to the transformer 530. The operation 810 may collect operational parameters including one or more of DC bus voltage measurements, DC current measurements from multiple power stacks, AC current measurements for each phase, power factor values, apparent power measurements, active power measurements, reactive power measurements, line-to-line voltage measurements, grid frequency measurements, or insulation monitoring device readings from the inverter 520. The operation 810 may simultaneously gather grid-side data including grid voltage measurements for each phase combination, total AC current measurements for each phase, and power measurements from the electric grid 540 connection point.

The method 800 may proceed to an operation 820 where the one or more processors apply a machine learning model to the data set to generate a determination that the data set meets one or more threshold values associated with a health assessment of the transformer 530. The operation 820 may process the collected data through the machine learning architecture described in the flow diagram 700, including analysis through the input layer 710, the transformer encoder layer 720, and the output layer 730. The machine learning model may analyze the operational data through multiple analytical pathways including WIND algorithm processing for winding health assessment and TAPE algorithm processing for tap changer performance evaluation.

The operation 820 may generate health indices including a winding health index and a tap changer health index based on the analysis of current imbalance ratios, power factor variations, temporal tracking values, and load response characteristics. The one or more threshold values may be determined based on one or more of the winding health index or the tap changer health index, enabling the machine learning model to identify when transformer conditions indicate potential degradation or developing fault patterns. The operation 820 may generate the winding health index and the tap changer health index at one or more intervals (e.g., per day, per week, per month, or a combination thereof). The operation 820 may compare the generated health indices against predetermined threshold values that may be dynamically adjusted based on operational conditions and historical performance patterns.

Following the health assessment analysis, the method 800 may advance to an operation 830 where the one or more processors generate a notification based on the determination that the data set meets the one or more threshold values. The operation 830 may create notifications that include early fault warnings with failure progression prediction, time-to-maintenance estimation, risk level classification, and actionable maintenance recommendations specific to identified transformer degradation patterns. The notification may provide component-specific health scores and overall system health indices that enable maintenance personnel to understand the severity and location of identified issues.

The method 800 may continue to an operation 840 where the one or more processors output the notification to appropriate system interfaces and personnel. The operation 840 may transmit the notification through the communication port or interface 320 to external monitoring systems, maintenance management systems, or operator interfaces. The operation 840 may display notification information through the display 310 or transmit alert messages through the network 370 to enable immediate awareness of transformer health conditions. The operation 840 may format the notification output to provide clear and actionable information for different types of system operators and maintenance personnel.

The method 800 may continue to an operation 850 where the one or more processors control one or more operations of the transformer 530 based on the notification. The operation 850 may implement automated control actions that improve transformer reliability and prevent failures in battery energy storage systems. The one or more operations of the transformer 530 may include one or more of scheduling a maintenance request, preventing one or more actions associated with the transformer 530, or optimizing one or more operations of the transformer 530.

The operation 850 may schedule maintenance requests by automatically generating work orders and maintenance schedules based on the predicted time-to-maintenance estimation and risk level classification provided in the notification. The automated maintenance scheduling may coordinate with existing maintenance management systems to optimize maintenance windows and resource allocation while preventing unexpected transformer failures. The operation 850 may prevent one or more actions associated with the transformer 530 by implementing protective control measures when the health assessment indicates conditions that may cause damage if normal operations continue.

The operation 850 may optimize one or more operations of the transformer 530 by adjusting operational parameters to reduce stress conditions identified through the health assessment analysis. The operational optimization may include load balancing adjustments, power factor correction, or voltage regulation modifications that may extend transformer operational life while maintaining system performance requirements. The controller 300 may implement energy efficient monitoring that activates only when needed and provides early detection capabilities for transformer degradation, reducing computational overhead while maintaining continuous health surveillance.

The method 800 may provide improvements over traditional transformer monitoring approaches by integrating predictive analytics directly into operational control systems. The automated control capabilities may enable proactive maintenance interventions that prevent costly transformer failures and system downtime. The method may eliminate the need for manual interpretation of monitoring data by providing direct control actions based on machine learning analysis of transformer health conditions. The integration of health assessment and operational control may improve overall battery energy storage system reliability by maintaining transformer performance within optimal operating parameters through predictive maintenance and operational optimization strategies.

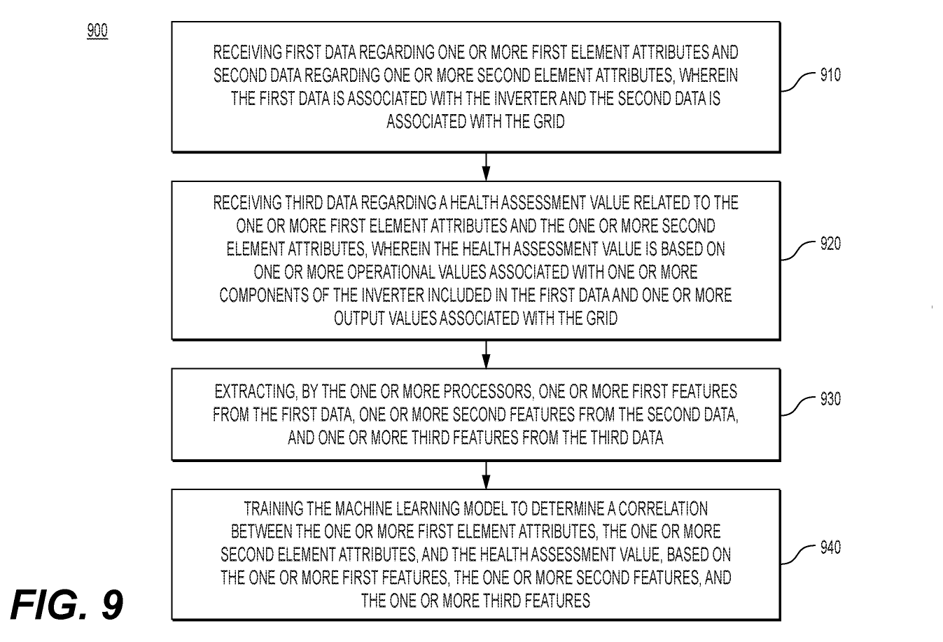

FIG. 9 depicts an exemplary flow diagram for training the machine learning model in operation 820 of FIG. 8, according to one or more embodiments. The method 900 may provide a systematic approach for developing the machine learning capabilities that enable the system 500 to correlate inverter behavior with transformer stress patterns through supervised learning techniques.

The method 900 may begin with an operation 910 where the one or more processors receive first data regarding one or more first element attributes and second data regarding one or more second element attributes. The first data may be associated with the inverter 520 and may include operational parameters such as DC bus voltage measurements, DC current measurements from multiple power stacks, AC current measurements for each phase, power factor values, apparent power measurements, active power measurements, reactive power measurements, line-to-line voltage measurements, and insulation monitoring device readings. The second data may be associated with the electric grid 540 and may include grid voltage measurements for each phase combination, total AC current measurements for each phase, and power measurements including apparent power, active power, and reactive power from the grid side of the transformer 530.

The method 900 may proceed to an operation 920 where the one or more processors receive third data regarding a health assessment value related to the one or more first element attributes and the one or more second element attributes. The health assessment value may be based on one or more operational values associated with one or more components of the inverter 520 included in the first data and one or more output values associated with the electric grid 540. The third data may include historical transformer performance data, maintenance records, inspection results, and known fault conditions that provide ground truth information for training the machine learning model to recognize patterns associated with transformer degradation.

The operation 920 may collect health assessment values that represent confirmed transformer conditions including insulation resistance measurements, thermal imaging results, dissolved gas analysis data, and tap changer performance metrics obtained during scheduled maintenance activities. The health assessment values may provide the supervised learning targets that enable the machine learning model to learn correlations between indirect measurements from the inverter 520 and the electric grid 540 and actual transformer health conditions.

Following data collection, the method 900 may advance to an operation 930 where the one or more processors extract one or more first features from the first data, one or more second features from the second data, and one or more third features from the third data. The extraction of the one or more first features or the one or more second features may include analysis of core issues, overfluxing conditions, DC bias, indirect cooling assessment, and correlation of grid events including voltage sag, voltage swell, under frequency, over frequency, poor power quality, and ground faults.

The one or more first features may include core issue analysis for the one or more components of the inverter 520, which may involve analyzing magnetic flux patterns and core loss indicators derived from power measurements and harmonic content analysis. The one or more first features may include an overfluxing value that represents conditions where the transformer 530 may operate beyond designed flux density limits due to voltage or frequency variations detected through grid frequency measurements and voltage magnitude analysis. The one or more first features may include a DC bias value that identifies direct current components in the transformer 530 that may cause core saturation and increased losses, derived from analysis of current waveform distortion and power quality measurements.

The one or more first features may include an indirect cooling assessment value that evaluates thermal management effectiveness through analysis of temperature-related operational parameters including load cycling patterns, ambient condition correlations, and efficiency degradation trends. The one or more first features may include one or more ground faults detected through insulation monitoring device readings and grounding system analysis that indicate insulation failures or developing electrical stress conditions.

The one or more second features may include grid event analysis that correlates transformer stress patterns with electrical grid disturbances. The one or more second features may include a voltage sag analysis that identifies temporary voltage reductions that may cause increased current draw and thermal stress in the transformer 530. The one or more second features may include a voltage swell analysis that detects temporary voltage increases that may cause overfluxing conditions and insulation stress. The one or more second features may include an underfrequency value that represents grid frequency conditions below nominal values that may affect transformer core flux density and magnetic performance.

The one or more second features may include an over frequency value that identifies grid frequency conditions above nominal values that may reduce transformer flux density and affect voltage regulation performance. The one or more second features may include a power quality value that quantifies harmonic distortion, voltage unbalance, and other power quality parameters that may contribute to transformer heating and insulation degradation over time.

The operation 930 may extract the one or more third features from the third data by processing historical health assessment information to identify patterns and correlations that indicate developing transformer degradation. The one or more third features may include trend analysis of insulation resistance measurements, thermal performance degradation patterns, and mechanical condition indicators that provide training targets for the machine learning model.

The method 900 may continue to an operation 940 where the one or more processors train the machine learning model to determine a correlation between the one or more first element attributes, the one or more second element attributes, and the health assessment value based on the one or more first features, the one or more second features, and the one or more third features. The operation 940 may utilize the training algorithm 420 and the training component 430 to process the extracted features and develop predictive relationships between indirect measurements and transformer health conditions.

The operation 940 may train the machine learning model to recognize patterns in inverter behavior that correlate with transformer stress conditions, enabling the system 500 to predict developing degradation without direct transformer monitoring. The training process may establish correlations between power quality variations detected through the inverter 520 and actual transformer insulation degradation measured during maintenance activities. The machine learning model may learn to associate current imbalance patterns with winding degradation, power factor variations with core losses, and thermal cycling patterns with insulation aging.

The training process may enable the machine learning model to distinguish between normal operational variations and developing fault conditions by analyzing the relationships between multiple operational parameters and confirmed health assessment outcomes. The operation 940 may incorporate feedback mechanisms through the associations 416 that allow the machine learning model to continuously improve its predictive accuracy based on operational experience and maintenance validation results.

The method 900 may provide the foundation for the predictive health monitoring capabilities implemented in the method 800, enabling the system 500 to generate accurate health assessments and control decisions based on indirect measurements from existing system components. The training process may eliminate the need for specialized transformer monitoring equipment by developing machine learning capabilities that extract transformer health information from readily available operational data.

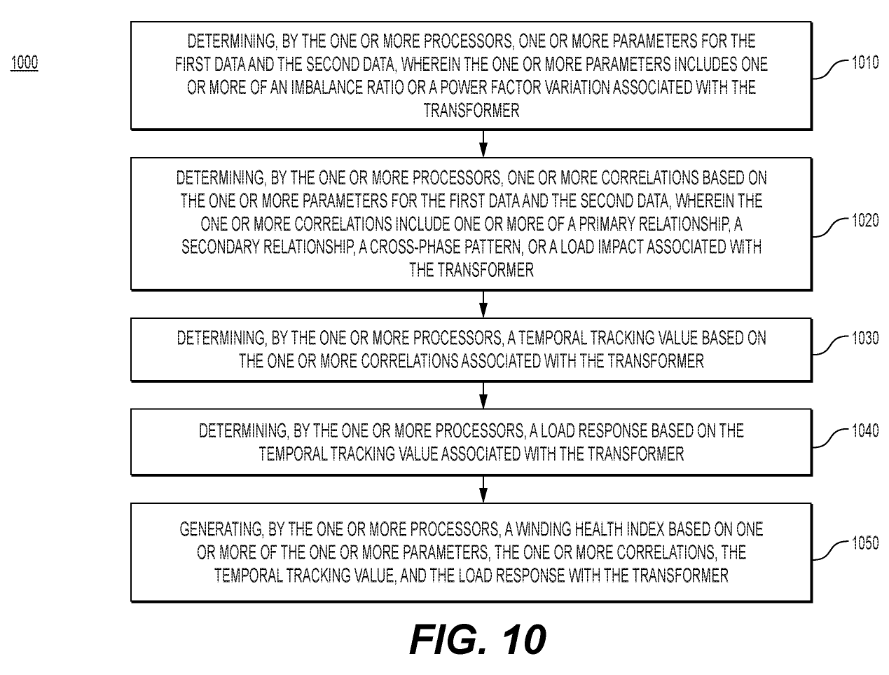

FIG. 10 depicts an exemplary flow diagram for generating a winding health index, according to one or more embodiments. The method 1000 may provide a systematic approach for implementing the WIND (Winding Intelligence & Degradation detection) algorithm that analyzes transformer winding health through comprehensive multi-factor assessment of electrical characteristics. The method 1000 may begin with an operation 1010 where the one or more processors determine one or more parameters for the first data and the second data, wherein the one or more parameters incudes one or more of an imbalance ratio or a power factor variation associated with the transformer 530.

The operation 1010 may determine current imbalance ratios by analyzing the AC current measurements for each phase collected from the inverter 520 and comparing phase current magnitudes to identify asymmetrical loading conditions that may indicate developing winding degradation. The current imbalance ratios may be determined by identifying the deviation of individual phase currents from the average three-phase current, providing an indicator of winding resistance variations or turn-to-turn faults within the transformer 530. The operation 1010 may analyze power factor variations by monitoring changes in the power factor values over time and correlating these variations with loading conditions and operational parameters.

The power factor variation analysis may identify deteriorating insulation conditions within the transformer 530 by detecting increases in reactive power consumption that may indicate developing dielectric losses or partial discharge activity. The operation 1010 may process the line-to-line voltage measurements to determine voltage imbalance parameters that complement the current imbalance analysis, providing a comprehensive assessment of electrical asymmetries that may affect transformer winding stress patterns.

The method 1000 may proceed to an operation 1020 where the one or more processors may determine one or more correlations based on the one or more parameters for the first data and the second data, wherein the one or more correlations include one or more of a primary relationship, a secondary relationship, a cross-phase pattern, or a load impact associated with the transformer 530. The operation 1020 may establish primary relationships by analyzing correlations between inverter-side measurements and transformer loading conditions, identifying how changes in DC bus voltage and power stack currents relate to transformer primary winding stress.

The operation 1020 may determine secondary relationships by correlating grid-side measurements with transformer secondary winding performance, analyzing how grid voltage variations and current patterns affect transformer output characteristics. The secondary relationship analysis may identify voltage regulation performance and load response characteristics that indicate transformer winding condition and tap changer functionality. The operation 1020 may detect cross-phase patterns by analyzing relationships between different phase measurements to identify asymmetrical conditions that may indicate winding degradation or core issues. The cross-phase pattern analysis may identify developing fault conditions by detecting correlations between phase imbalances and harmonic content that may indicate turn-to-turn faults or winding deformation. The operation 1020 may assess load impact by correlating transformer loading conditions with electrical parameter variations, identifying how different load levels affect transformer performance and stress patterns.

The method 1000 may advance to an operation 1030 where the one or more processors determine a temporal tracking value based on the one or more correlations associated with the transformer 530. The operation 1030 may implement temporal tracking by analyzing long-term trends associated with the transformer 530, monitoring how the correlations established in the operation 1020 change over extended time periods to identify gradual degradation patterns that may not be apparent in short-term measurements. The operation 1030 may perform pattern recognition based on the long-term trends by identifying recurring patterns in the correlation data that may indicate seasonal variations, load cycling effects, or progressive degradation conditions. For example, the pattern recognition analysis may distinguish between normal operational variations and developing fault conditions by analyzing historical correlation patterns and comparing current measurements against established baseline performance characteristics.

The operation 1030 may detect one or more anomalies in the first data and second data over a predetermined time period to identify degradation patterns in the transformer 530. The anomaly detection may identify deviations from normal correlation patterns that may indicate developing insulation degradation, winding deformation, or thermal stress conditions. The predetermined time period may be configured based on transformer type, operational conditions, and maintenance schedules to provide appropriate sensitivity for early fault detection while reducing false alarms from normal operational variations. The temporal tracking value may quantify the rate of change in transformer performance characteristics, providing a metric that indicates whether degradation patterns are accelerating or stabilizing. The temporal tracking analysis may incorporate seasonal corrections and load cycle normalization to improve the accuracy of degradation trend identification.

The method 1000 may continue to an operation 1040 where the one or more processors may determine a load response based on the temporal tracking value associated with the transformer 530. The operation 1040 may analyze load-dependent behavior by correlating the temporal tracking value with transformer loading conditions to identify how winding performance changes under different operational stress levels. The load response analysis may assess efficiency tracking by monitoring how transformer losses and power transfer characteristics change with loading conditions and time.

The operation 1040 may evaluate transformer response to load variations by analyzing how quickly and accurately the transformer 530 responds to changes in power demand, identifying performance degradation that may indicate winding or core issues. The load response determination may incorporate analysis of one or more of voltage regulation characteristics, reactive power requirements, or harmonic generation patterns that may indicate developing transformer problems.

The method 1000 may continue to an operation 1050 where the one or more processors may generate a winding health index based on one or more of the one or more parameters, the one or more correlations, the temporal tracking value, or the load response with the transformer 530. The operation 1050 may combine the analytical results from the previous operations creating a winding health index percentage that represents the overall condition of the transformer 530 windings.

The winding health index may be determined by weighting the contributions from the imbalance ratios and power factor variations determined in the operation 1010, the primary relationships, secondary relationships, cross-phase patterns, and load impacts established in the operation 1020, the temporal tracking value determined in the operation 1030, and the load response characteristics determined in the operation 1040. The weighting factors may be determined through machine learning training that correlates the analytical parameters with actual transformer condition assessments obtained during maintenance activities.

The operation 1050 may normalize the winding health index to a percentage scale where higher values indicate better transformer condition and lower values indicate developing degradation that may require maintenance intervention. The winding health index may provide a standardized metric that enables comparison of transformer condition across different units and time periods, supporting predictive maintenance scheduling and operational optimization decisions.

The WIND algorithm implementation through the method 1000 may provide a winding health assessment through multi-factor analysis of transformer electrical characteristics without requiring direct transformer monitoring equipment. The systematic analysis of parameters, correlations, temporal tracking, and load response may enable early detection of winding degradation patterns that may not be apparent through individual parameter monitoring approaches.

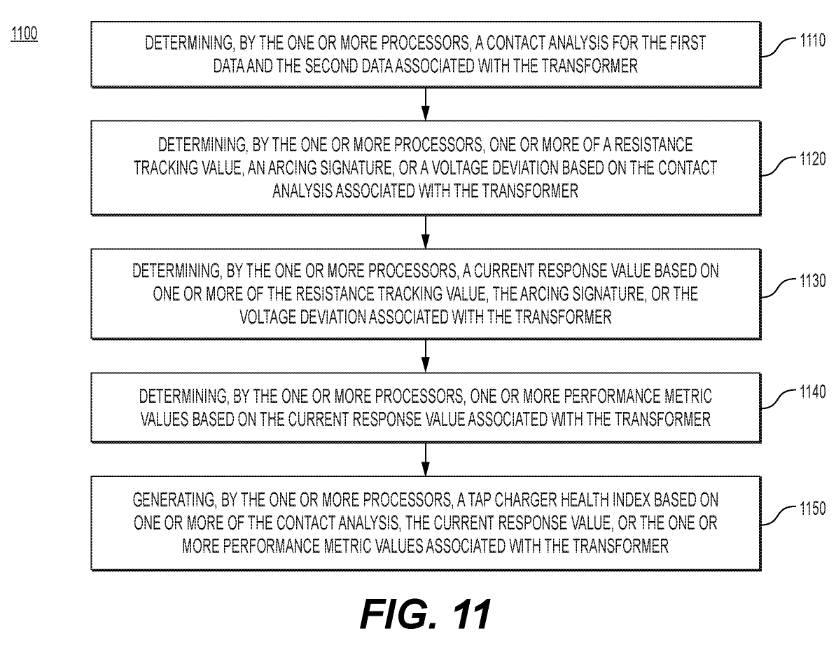

FIG. 11 depicts an exemplary flow diagram for generating a tap changer health index, according to one or more embodiments. The method 1100 may provide a systematic approach for implementing the TAPE (Tap-changer Analytics & Performance Evaluation) algorithm that evaluates tap changer health through comprehensive analysis of contact conditions and electrical responses. The method 1100 may begin with an operation 1110 where the one or more processors determine a contact analysis for the first data and the second data associated with the transformer 530. The operation 1110 may perform contact analysis by evaluating electrical contact conditions within the tap changer mechanism through analysis of voltage and current measurements collected from the inverter 520 and the electric grid 540. The contact analysis may assess the electrical integrity of tap changer contacts by monitoring voltage drop characteristics across switching positions and identifying irregularities that may indicate contact degradation or contamination. The operation 1110 may analyze switching transients and voltage variations that occur during tap changer operations to evaluate contact performance and mechanical condition.

The contact analysis may incorporate examination of harmonic content and electrical noise patterns that may indicate arcing or poor contact conditions during tap changer switching operations. The operation 1110 may correlate tap changer position data with voltage regulation performance to assess the effectiveness of contact engagement and current carrying capacity across different tap positions. The contact analysis may identify developing contact resistance issues by monitoring voltage regulation accuracy and response characteristics under varying load conditions.

The method 1100 may proceed to an operation 1120 where the one or more processors may determine one or more of a resistance tracking value, an arcing signature, or a voltage deviation based on the contact analysis associated with the transformer 530. The operation 1120 may determine resistance tracking values by analyzing voltage drop measurements across tap changer contacts and correlating these measurements with current loading conditions to identify increases in contact resistance that may indicate oxidation, contamination, or mechanical wear.

The resistance tracking analysis may monitor changes in contact resistance over time by comparing voltage regulation performance across different tap positions and loading conditions. The operation 1120 may detect arcing signatures by analyzing high-frequency transients and electromagnetic patterns in the operational data that indicate electrical discharge activity during tap changer switching operations. The arcing signature detection may identify contact erosion or contamination conditions that may lead to tap changer failure if not addressed through maintenance intervention.

The operation 1120 may determine voltage deviations by comparing actual voltage regulation performance against expected performance characteristics for each tap position. The voltage deviation analysis may identify tap changer mechanical issues, contact alignment problems, or winding connection irregularities that affect voltage regulation accuracy. The operation 1120 may correlate voltage deviations with load conditions and environmental factors to distinguish between normal operational variations and developing tap changer degradation.

The method 1100 may advance to an operation 1130 where the one or more processors may determine a current response value based on one or more of the resistance tracking value, the arcing signature, or the voltage deviation associated with the transformer 530. The operation 1130 may analyze current response characteristics by evaluating how tap changer performance may affect current distribution and power transfer efficiency under different loading conditions.

The current response analysis may assess load impact by monitoring how tap changer condition affects current balance between phases and power quality parameters. The operation 1130 may evaluate current deviations that may result from tap changer contact resistance variations or mechanical positioning errors. The current response value may quantify the impact of tap changer condition on overall transformer electrical performance by analyzing power transfer efficiency and reactive power requirements across different tap positions.

The operation 1130 may incorporate balance tracking analysis that monitors three-phase current symmetry and identifies imbalances that may result from tap changer contact irregularities or mechanical misalignment. The current response determination may correlate tap changer switching events with transient current patterns to assess switching performance and identify developing mechanical or electrical issues.

The method 1100 may continue to an operation 1140 where the one or more processors may determine one or more performance metric values based on the current response value associated with the transformer 530. The operation 1140 may generate efficiency metrics by analyzing power transfer characteristics and loss patterns that may be affected by tap changer condition. The performance metric evaluation may assess voltage regulation accuracy by comparing actual voltage control performance against design specifications across different tap positions and loading conditions.

The operation 1140 may determine response time metrics by analyzing the speed and accuracy of voltage regulation adjustments during load changes or grid voltage variations. The response time analysis may identify mechanical degradation in tap changer drive mechanisms or control system issues that may affect voltage regulation performance. The operation 1140 may evaluate switching frequency patterns and correlate these patterns with tap changer mechanical condition and electrical performance.

The performance metric values may include assessment of tap changer operational reliability by monitoring successful switching operations and identifying failed or incomplete switching events that may indicate developing mechanical or electrical problems. The operation 1140 may analyze maintenance interval requirements by correlating performance degradation patterns with operational history and environmental conditions.

The method 1100 may continue to an operation 1150 where the one or more processors may generate the tap changer health index based on one or more of the contact analysis, the current response value, or the one or more performance metric values associated with the transformer 530. The operation 1150 may combine the analytical results from the contact analysis performed in the operation 1110, the resistance tracking values, arcing signatures, and voltage deviations determined in the operation 1120, the current response values determined in the operation 1130, and the performance metric values established in the operation 1140.

The tap changer health index may be generated by weighing the contributions from each analytical component to create a comprehensive assessment of tap changer condition. The weighting factors may be determined through machine learning training that correlates the analytical parameters with actual tap changer condition assessments obtained during maintenance inspections and performance testing. The operation 1150 may normalize the tap changer health index to a percentage scale where higher values indicate better tap changer condition and lower values indicate developing degradation that may require maintenance intervention.

The tap changer health index may provide a standardized metric that enables comparison of tap changer condition across different transformers and time periods, supporting predictive maintenance scheduling and operational optimization decisions. The operation 1150 may incorporate trend analysis capabilities that monitor changes in the tap changer health index over time to identify acceleration or stabilization of degradation patterns.

The TAPE algorithm implementation through the method 1100 may provide tap changer health evaluation through systematic analysis of contact conditions and electrical responses without requiring specialized tap changer monitoring equipment. Analyzing one or more of contact analysis, resistance tracking, arcing detection, voltage deviation assessment, current response evaluation, or performance metrics may enable early detection of tap changer degradation patterns that may affect transformer voltage regulation performance and overall system reliability.

One or more embodiments may provide alternative implementations for transformer health monitoring that may receive operational data directly from a transformer connected to a power conversion system of a battery energy storage system. The operational data may include electrical measurements, thermal parameters, and performance indicators that may be collected through existing monitoring infrastructure or specialized sensors integrated with the transformer. The operational data may encompass voltage measurements across transformer windings, current flow patterns through primary and secondary circuits, temperature readings from multiple transformer locations, and insulation resistance values measured during operational conditions.

The method may analyze insulation resistance degradation patterns in the operational data by processing electrical measurements that indicate changes in dielectric properties within the transformer insulation system. The analysis of insulation resistance degradation patterns may include monitoring changes in one or more properties over time, where the one or more properties may include dielectric constant variations, polarization index measurements, and dissipation factor changes that indicate progressive insulation deterioration. The monitoring of changes over time may track insulation resistance values across multiple measurement periods to identify gradual degradation trends that may precede insulation failure.

The analysis may correlate temperature cycling effects with insulation aging by examining relationships between thermal stress patterns and insulation resistance measurements. The temperature cycling correlation may identify how repeated heating and cooling cycles may accelerate insulation aging through thermal expansion and contraction effects that may cause mechanical stress within the insulation system. The correlation analysis may account for ambient temperature variations, load-induced heating cycles, and seasonal temperature changes that may contribute to cumulative insulation degradation over the operational lifetime of the transformer.

The method may detect partial discharge activity based on voltage stress indicators in the operational data through analysis of electrical phenomena that may indicate developing insulation failures. The detection of partial discharge activity may include analyzing high-frequency transients and electromagnetic patterns that indicate discharge within the transformer. The high-frequency transient analysis may identify electrical pulses and current spikes that may occur when insulation breakdown creates localized discharge events within the transformer dielectric system. The electromagnetic pattern analysis may detect radio frequency emissions and electromagnetic interference signatures that may be generated by partial discharge activity within transformer windings or insulation structures. The partial discharge detection may correlate voltage stress indicators with discharge frequency and magnitude to assess the severity and progression of insulation degradation. The voltage stress analysis may identify operating conditions where electrical field strength may exceed insulation design limits, creating conditions that may promote partial discharge initiation and propagation.

The method may generate a transformer health assessment based on the insulation resistance degradation patterns and the partial discharge activity by combining multiple analytical results into a comprehensive condition evaluation. The transformer health assessment may integrate insulation resistance trends, partial discharge severity indicators, and voltage stress analysis results to provide an overall evaluation of transformer dielectric condition. The health assessment may quantify the risk of insulation failure and estimate the remaining operational life of the transformer insulation system based on current degradation rates and stress conditions.

The method may initiate a maintenance action when the transformer health assessment indicates degradation beyond a predetermined threshold. The maintenance action initiation may include automated scheduling of insulation testing, replacement of degraded components, or implementation of operational modifications to reduce electrical stress on the transformer insulation system. The predetermined threshold may be established based on industry standards, manufacturer recommendations, and operational experience to provide appropriate warning of developing insulation problems before they progress to failure conditions.

One or more embodiments may provide a method for predictive maintenance scheduling in battery energy storage systems that may collect performance degradation data from multiple components of a battery energy storage system including power conversion systems and transformers. The performance degradation data collection may encompass operational parameters, efficiency measurements, and condition indicators from batteries, inverters, transformers, and auxiliary systems within the battery energy storage system. The data collection may monitor component performance trends over extended time periods to identify gradual degradation patterns that may indicate approaching maintenance requirements.

The method may apply a machine learning algorithm to identify failure progression patterns in the performance degradation data by processing historical performance information and correlating degradation indicators with component failure modes. The machine learning algorithm may analyze relationships between different degradation parameters to identify patterns that may precede component failures. The failure progression pattern identification may distinguish between normal aging processes and accelerated degradation conditions that may require immediate maintenance intervention.

The method may generate remaining useful life estimates for each of the multiple components based on the failure progression patterns identified through machine learning analysis. The generation of remaining useful life estimates may include analyzing component stress factors, operational history, and environmental conditions to predict time-to-failure with confidence intervals. The component stress factor analysis may evaluate electrical loading, thermal cycling, mechanical vibration, and environmental exposure conditions that may contribute to component degradation rates.

The operational history analysis may examine maintenance records, performance trends, and failure patterns from similar components to establish baseline degradation rates and failure probability distributions. The environmental condition analysis may account for temperature variations, humidity levels, contamination exposure, and other external factors that may influence component degradation rates. The confidence interval determination may provide statistical bounds on the remaining useful life estimates to account for uncertainty in degradation modeling and environmental variability.

The method may optimize maintenance schedules to reduce system downtime while preventing component failures through coordinated planning of maintenance activities across multiple system components. The maintenance schedule optimization may include coordinating maintenance windows across multiple battery energy storage systems to maintain grid stability and energy supply continuity. The coordination of maintenance windows may ensure that maintenance activities may be scheduled during periods of low energy demand or when alternative energy sources may provide backup power capacity.

The optimization process may balance maintenance costs, system availability requirements, and component failure risks to develop maintenance schedules that may increase system reliability while reducing operational disruptions. The method may automatically schedule maintenance activities based on the optimized maintenance schedules by integrating with maintenance management systems and resource planning tools. The automatic scheduling may generate work orders, allocate maintenance personnel, and coordinate material procurement to ensure that maintenance activities may be completed within the optimized time windows.

The predictive maintenance scheduling method may provide improvements over traditional time-based maintenance approaches by enabling condition-based maintenance decisions that may extend component operational life while maintaining system reliability. The integration of multiple component degradation analyses may enable system-level maintenance optimization that may account for interdependencies between different battery energy storage system components. The automated scheduling capabilities may reduce maintenance planning overhead while ensuring that maintenance activities may be completed before component failures may occur.

The health monitoring system may provide significant operational and economic benefits for battery energy storage systems by enabling predictive maintenance approaches that may prevent unexpected transformer failures and reduce system downtime. The system may eliminate the need for expensive specialized transformer monitoring equipment by utilizing existing inverter and grid-side measurements to assess transformer health conditions through machine learning analysis. This indirect monitoring approach may reduce capital expenditure requirements while providing comprehensive health assessment capabilities that may detect insulation degradation, thermal stress patterns, and electrical stress conditions before they progress to failure states. The system may generate standardized health indices and predictive analytics that may enable maintenance personnel to schedule interventions based on actual component condition rather than fixed time intervals, potentially extending transformer operational life while maintaining safety and reliability standards.

The machine learning-based architecture may provide real-time processing capabilities with approximately one-minute execution cycles that may enable immediate response to developing fault conditions while incorporating continuous learning features that may improve prediction accuracy over time through operational experience integration. The system may offer early fault detection and failure progression prediction that may provide advance warning of potential component failures, enabling proactive maintenance scheduling that may reduce system downtime and reduce maintenance costs. For voltage transformers with lead times of approximately one year for replacement, the predictive capabilities may prevent costly emergency replacements and extended outages that may significantly impact site operations and energy delivery commitments. The automated control capabilities may optimize transformer operation through load balancing adjustments and operational parameter modifications that may reduce stress conditions while maintaining system performance requirements, contributing to improved overall battery energy storage system reliability and efficiency.

It should be understood that the foregoing description is intended to illustrate, and not to limit, the scope of the present disclosure. Other embodiments will be apparent to those skilled in the art in view of this description. For example, while certain embodiments are described with respect to lithium-ion batteries, the disclosed structures, materials, and methods may be applied to next-generation energy storage devices including, without limitation, solid-state batteries employing solid electrolytes, lithium-metal or lithium-sulfur chemistries, sodium-ion systems, multivalent-ion systems (e.g., magnesium, calcium, aluminum), zinc-based or redox flow batteries, and metal-air cells. Still further embodiments may include architectures employing silicon-based anodes, cobalt-free cathodes, or advanced electrolyte formulations. In some cases, anode-less designs, in which active material is plated during charge, or separator-free designs, in which the electrolyte provides ionic conduction and electronic insulation without a discrete separator, may be implemented. The present disclosure also contemplates hybridized devices combining electrochemical cells with supercapacitors, as well as integration into applications such as electric or hybrid vehicles, stationary energy storage systems, aerospace platforms, and portable electronics. Accordingly, the scope of the present invention should be determined not by the particular embodiments described, but by reference to the appended claims and their equivalents.

The present disclosure further relates to the following aspects.

Example 1. A method comprising: receiving, by one or more processors, a data set associated with an inverter and a grid connected to a transformer; determining one or more threshold values based on one or more of winding health index or a tap changer health index associated with the transformer; applying, by the one or more processors, a machine learning model to the data set to generate a determination that the data set meets the one or more threshold values associated with a health assessment of the transformer, wherein the machine learning model is configured to predict the winding health index or the tap changer health index at one or more intervals; and controlling, by the one or more processors, one or more operations of the transformer based on the determination that the data set meets the one or more threshold values associated with the health assessment of the transformer.

Example 2. The method of example 1, wherein the machine learning model is trained by: receiving first data regarding one or more first element attributes and second data regarding one or more second element attributes, wherein the first data is associated with the inverter and the second data is associated with the grid; extracting, by the one or more processors, one or more first features from the first data and extracting one or more second features from the second data; and training the machine learning model to determine a correlation between the one or more first element attributes, the one or more second element attributes, and the health assessment, based on the one or more first features and the one or more second features.

Example 3. The method of example 2, wherein the machine learning model is further trained by: receiving third data regarding the health assessment related to the one or more first element attributes and the one or more second element attributes, wherein the health assessment is based on one or more operational values associated with one or more components of the inverter included in the first data and one or more output values associated with the grid; extracting a third feature from the third data; and training the machine learning model to determine a correlation between the one or more first element attributes, the one or more second element attributes, and the health assessment, based on the one or more first features, the one or more second features, and the third feature.

Example 4. The method of example 3, wherein the one or more first features include one or more of a core issue analysis for the one or more components of the inverter, an overfluxing value, a DC bias value, an indirect cooling assessment value, or one or more ground faults, wherein the one or more second features include one or more of a voltage sag, a voltage swell, an underfrequency value, an over frequency value, or a power quality value.

Example 5. The method of example 2, wherein extracting the one or more first features or the one or more second features includes: determining, by the one or more processors, one or more parameters for the first data and the second data, wherein the one or more parameters includes one or more of an imbalance ratio or a power factor variation associated with the transformer; determining, by the one or more processors, one or more correlations based on the one or more parameters for the first data and the second data, wherein the one or more correlations include one or more of a primary relationship, a secondary relationship, a cross-phase pattern, or a load impact associated with the transformer; determining, by the one or more processors, a temporal tracking value based on the one or more correlations associated with the transformer; determining, by the one or more processors, a load response based on the temporal tracking value associated with the transformer; and generating, by the one or more processors, the winding health index based on one or more of the one or more parameters, the one or more correlations, the temporal tracking value, and the load response with the transformer.

Example 6. The method of example 5, wherein determining the temporal tracking value further includes: analyzing long-term trends associated with the transformer; performing pattern recognition based on the long-term trends; and detecting one or more anomalies in the first data and the second data over a predetermined time period to identify degradation patterns in the transformer.

Example 7. The method of example 6, wherein extracting the one or more first features or the one or more second features includes: determining, by the one or more processors, a contact analysis for the first data and the second data associated with the transformer; determining, by the one or more processors, one or more of a resistance tracking value, an arcing signature, or a voltage deviation based on the contact analysis associated with the transformer; determining, by the one or more processors, a current response value based on one or more of the resistance tracking value, the arcing signature, or the voltage deviation associated with the transformer; determining, by the one or more processors, one or more performance metric values based on the current response value associated with the transformer; and generating, by the one or more processors, the tap changer health index based on one or more of the contact analysis, the current response value, or the one or more performance metric values associated with the transformer.

Example 8. The method of example 1, further comprising: generating, by the one or more processors, a notification based on the determination that the data set meets the one or more threshold values; and outputting, by the one or more processors, the notification.

Example 9. The method of example 8, wherein the notification includes one or more of an early fault warning with failure progression prediction, a time-to-maintenance estimation, a risk level classification, or one or more actionable maintenance recommendations specific to identified transformer degradation patterns.

Example 10. The method of example 1, wherein the one or more operations of the transformer include one or more of outputting a notification, scheduling a maintenance request, preventing one or more actions associated with the transformer, or optimizing the one or more operations of the transformer.

Example 11. The method of example 1, wherein determining the one or more threshold values further includes: determining the one or more threshold values based on one or more component-specific health scores associated with one or more components of the inverter.

Example 12. The method of example 1, wherein the one or more intervals includes one or more of a day, a week, or a month.

Example 13. The method of example 1, wherein the data set includes one or more of a DC bus voltage measurement, a DC current measurement from multiple power stacks, an AC current measurement for each phase, one or more power factor values, an apparent power measurement, an active power measurement, a reactive power measurement, a line-to-line voltage measurement, a grid frequency measurement, or an insulation monitoring device reading.

Example 14. The method of example 1, wherein the machine learning model executes in real-time processing cycles of approximately one minute and includes a dynamic threshold adjustment to adapt the one or more threshold values based on the data set.

Example 15. A method for transformer health monitoring in a battery energy storage system, the method comprising: receiving, by one or more processors, operational data from a transformer connected to a power conversion system of the battery energy storage system; applying, by the one or more processors, a machine learning model to the operational data from the transformer to generate a determination that the operational data meets one or more threshold values associated with a transformer health assessment, wherein applying the machine learning model to the operational data includes: detecting, by the one or more processors, insulation resistance degradation patterns in the operational data, detecting, by the one or more processors, partial discharge activity based on voltage stress indicators in the operational data, and generating, by the one or more processors, the transformer health assessment based on the insulation resistance degradation patterns and the partial discharge activity; and initiating, by the one or more processors, a maintenance action when the transformer health assessment meets the one or more threshold values.

Example 16. The method of example 15, wherein detecting the insulation resistance degradation patterns includes analyzing changes in one or more properties of the transformer over time and correlating temperature cycling effects with insulation aging.

Example 17. The method of example 15, wherein detecting the partial discharge activity includes analyzing high-frequency transients and electromagnetic patterns that indicate discharge within the transformer.

Example 18. A method for training a machine learning model to predict a health of a transformer in a battery energy storage system, the method comprising: receiving, by one or more processors, first data regarding one or more element attributes associated with the transformer, wherein the first data includes a plurality of operational parameters; extracting, by the one or more processors, one or more first features from the first data based on analyzing processing algorithms identifying one or more inverter operational parameters; extracting, by the one or more processors, one or more second features from second data, wherein the second data includes one or more grid operational parameters; training, by the one or more processors, the machine learning model to determine correlations between the one or more element attributes and one or more health assessment values based on the one or more first features and the one or more second features; and validating, by the one or more processors, the trained machine learning model using validation data.

Example 19. The method of example 18, wherein the plurality of operational parameters include one or more of a plurality of DC bus voltage measurements, a plurality of multi-stack current readings, a plurality of three-phase AC measurements, a plurality of line-to-line measurements, or a plurality of grid voltage measurements.

Example 20. The method of example 18, wherein the one or more health assessment values include one or more of a winding health index, a tap changer index, a contact analysis, or a performance metrics value.

Example 21. A system for controlling one or more operations of a transformer, the system comprising: one or more processors; and one or more memories storing instructions that, when executed by the one or more processors, cause the one or more processors to perform operations including: receive a data set associated with an inverter and a grid connected to a transformer; determine one or more threshold values based on one or more of winding health index or a tap changer health index associated with the transformer; apply a machine learning model to the data set to generate a determination that the data set meets the one or more threshold values associated with a health assessment of the transformer, wherein the machine learning model is configured to predict the winding health index or the tap changer health index at one or more intervals; and control one or more operations of the transformer based on the determination that the data set meets the one or more threshold values associated with the health assessment of the transformer.

Example 22. The system of example 21, wherein the operations further include any of examples 2 to 14.

Example 23. A system for transformer health monitoring in a battery energy storage system, the system comprising: one or more processors; and one or more memories storing instructions that, when executed by the one or more processors, cause the one or more processors to perform operations including: receive operational data from a transformer connected to a power conversion system of the battery energy storage system; apply a machine learning model to the operational data from the transformer to generate a determination that the operational data meets one or more threshold values associated with a transformer health assessment, wherein applying the machine learning model to the operational data includes: detect insulation resistance degradation patterns in the operational data, detect partial discharge activity based on voltage stress indicators in the operational data, and generate the transformer health assessment based on the insulation resistance degradation patterns and the partial discharge activity; and initiate a maintenance action when the transformer health assessment meets the one or more threshold values.

Example 24. The system of example 23, wherein the operations further include any of examples 16 to 17.

Example 25. A system for training a machine learning model to predict a health of a transformer in a battery energy storage system, the system comprising: one or more processors; and one or more memories storing instructions that, when executed by the one or more processors, cause the one or more processors to perform operations including: receive first data regarding one or more element attributes associated with the transformer, wherein the first data includes a plurality of operational parameters; extract one or more first features from the first data based on analyzing processing algorithms identifying one or more inverter operational parameters; extract one or more second features from second data, wherein the second data includes one or more grid operational parameters; train the machine learning model to determine correlations between the one or more element attributes and one or more health assessment values based on the one or more first features and the one or more second features; and validate the trained machine learning model using validation data.

Example 26. The system of example 25, wherein the operations further include any of examples 19 to 20.

Example 27. A non-transitory computer-readable medium for controlling one or more operations of a transformer, storing instructions that, when executed by one or more processors, cause the one or more processors to: receive a data set associated with an inverter and a grid connected to a transformer; determine one or more threshold values based on one or more of winding health index or a tap changer health index associated with the transformer; apply a machine learning model to the data set to generate a determination that the data set meets the one or more threshold values associated with a health assessment of the transformer, wherein the machine learning model is configured to predict the winding health index or the tap changer health index at one or more intervals; and control one or more operations of the transformer based on the determination that the data set meets the one or more threshold values associated with the health assessment of the transformer.

Example 28. The non-transitory computer readable medium of example 27, wherein the operations further include any of examples 2 to 14.

Example 29. A non-transitory computer readable medium for transformer health monitoring in a battery energy storage system, storing instructions that, when executed by one or more processors, cause the one or more processors to: receive operational data from a transformer connected to a power conversion system of the battery energy storage system; apply a machine learning model to the operational data from the transformer to generate a determination that the operational data meets one or more threshold values associated with a transformer health assessment, wherein applying the machine learning model to the operational data includes: detect insulation resistance degradation patterns in the operational data, detect partial discharge activity based on voltage stress indicators in the operational data, and generate the transformer health assessment based on the insulation resistance degradation patterns and the partial discharge activity; and initiate a maintenance action when the transformer health assessment meets the one or more threshold values.

Example 30. The non-transitory computer readable medium of example 29, wherein the operations further include any of examples 16 to 17.

Example 31. A non-transitory computer readable medium for training a machine learning model to predict a health of a transformer in a battery energy storage system, storing instructions that, when executed by one or more processors, cause the one or more processors to: receive first data regarding one or more element attributes associated with the transformer, wherein the first data includes a plurality of operational parameters; extract one or more first features from the first data based on analyzing processing algorithms identifying one or more inverter operational parameters; extract one or more second features from second data, wherein the second data includes one or more grid operational parameters; train the machine learning model to determine correlations between the one or more element attributes and one or more health assessment values based on the one or more first features and the one or more second features; and validate the trained machine learning model using validation data.

Example 32. The non-transitory computer readable medium of example 31, wherein the operations further include any of examples 19 to 20.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
receiving, by one or more processors, a data set associated with an inverter and a grid connected to a transformer;
determining one or more threshold values based on one or more of winding health index or a tap changer health index associated with the transformer;
applying, by the one or more processors, a machine learning model to the data set to generate a determination that the data set meets the one or more threshold values associated with a health assessment of the transformer, wherein the machine learning model is configured to predict the winding health index or the tap changer health index at one or more intervals; and
controlling, by the one or more processors, one or more operations of the transformer based on the determination that the data set meets the one or more threshold values associated with the health assessment of the transformer.

2. The method of claim 1, wherein the machine learning model is trained by:
receiving first data regarding one or more first element attributes and second data regarding one or more second element attributes, wherein the first data is associated with the inverter and the second data is associated with the grid;
extracting, by the one or more processors, one or more first features from the first data and extracting one or more second features from the second data; and
training the machine learning model to determine a correlation between the one or more first element attributes, the one or more second element attributes, and the health assessment, based on the one or more first features and the one or more second features.

3. The method of claim 2, wherein the machine learning model is further trained by:
receiving third data regarding the health assessment related to the one or more first element attributes and the one or more second element attributes, wherein the health assessment is based on one or more operational values associated with one or more components of the inverter included in the first data and one or more output values associated with the grid;
extracting a third feature from the third data; and
training the machine learning model to determine a correlation between the one or more first element attributes, the one or more second element attributes, and the health assessment, based on the one or more first features, the one or more second features, and the third feature.

4. The method of claim 3, wherein the one or more first features include one or more of a core issue analysis for the one or more components of the inverter, an overfluxing value, a DC bias value, an indirect cooling assessment value, or one or more ground faults,
wherein the one or more second features include one or more of a voltage sag, a voltage swell, an underfrequency value, an over frequency value, or a power quality value.

5. The method of claim 2, wherein extracting the one or more first features or the one or more second features includes:
determining, by the one or more processors, one or more parameters for the first data and the second data, wherein the one or more parameters includes one or more of an imbalance ratio or a power factor variation associated with the transformer;
determining, by the one or more processors, one or more correlations based on the one or more parameters for the first data and the second data, wherein the one or more correlations include one or more of a primary relationship, a secondary relationship, a cross-phase pattern, or a load impact associated with the transformer;
determining, by the one or more processors, a temporal tracking value based on the one or more correlations associated with the transformer;
determining, by the one or more processors, a load response based on the temporal tracking value associated with the transformer; and
generating, by the one or more processors, the winding health index based on one or more of the one or more parameters, the one or more correlations, the temporal tracking value, and the load response with the transformer.

6. The method of claim 5, wherein determining the temporal tracking value further includes:
analyzing long-term trends associated with the transformer;
performing pattern recognition based on the long-term trends; and
detecting one or more anomalies in the first data and the second data over a predetermined time period to identify degradation patterns in the transformer.

7. The method of claim 6, wherein extracting the one or more first features or the one or more second features includes:
determining, by the one or more processors, a contact analysis for the first data and the second data associated with the transformer;
determining, by the one or more processors, one or more of a resistance tracking value, an arcing signature, or a voltage deviation based on the contact analysis associated with the transformer;
determining, by the one or more processors, a current response value based on one or more of the resistance tracking value, the arcing signature, or the voltage deviation associated with the transformer;
determining, by the one or more processors, one or more performance metric values based on the current response value associated with the transformer; and
generating, by the one or more processors, the tap changer health index based on one or more of the contact analysis, the current response value, or the one or more performance metric values associated with the transformer.

8. The method of claim 1, further comprising:
generating, by the one or more processors, a notification based on the determination that the data set meets the one or more threshold values; and
outputting, by the one or more processors, the notification.

9. The method of claim 8, wherein the notification includes one or more of an early fault warning with failure progression prediction, a time-to-maintenance estimation, a risk level classification, or one or more actionable maintenance recommendations specific to identified transformer degradation patterns.

10. The method of claim 1, wherein the one or more operations of the transformer include one or more of outputting a notification, scheduling a maintenance request, preventing one or more actions associated with the transformer, or optimizing the one or more operations of the transformer.

11. The method of claim 1, wherein determining the one or more threshold values further includes:
determining the one or more threshold values based on one or more component-specific health scores associated with one or more components of the inverter.

12. The method of claim 1, wherein the one or more intervals includes one or more of a day, a week, or a month.

13. The method of claim 1, wherein the data set includes one or more of a DC bus voltage measurement, a DC current measurement from multiple power stacks, an AC current measurement for each phase, one or more power factor values, an apparent power measurement, an active power measurement, a reactive power measurement, a line-to-line voltage measurement, a grid frequency measurement, or an insulation monitoring device reading.

14. The method of claim 1, wherein the machine learning model executes in real-time processing cycles of approximately one minute and includes a dynamic threshold adjustment to adapt the one or more threshold values based on the data set.

15. A method for transformer health monitoring in a battery energy storage system, the method comprising:
receiving, by one or more processors, operational data from a transformer connected to a power conversion system of the battery energy storage system;
applying, by the one or more processors, a machine learning model to the operational data from the transformer to generate a determination that the operational data meets one or more threshold values associated with a transformer health assessment,
wherein applying the machine learning model to the operational data includes:
detecting, by the one or more processors, insulation resistance degradation patterns in the operational data,
detecting, by the one or more processors, partial discharge activity based on voltage stress indicators in the operational data, and
generating, by the one or more processors, the transformer health assessment based on the insulation resistance degradation patterns and the partial discharge activity; and
initiating, by the one or more processors, a maintenance action when the transformer health assessment meets the one or more threshold values.

16. The method of claim 15, wherein detecting the insulation resistance degradation patterns includes analyzing changes in one or more properties of the transformer over time and correlating temperature cycling effects with insulation aging.

17. The method of claim 15, wherein detecting the partial discharge activity includes analyzing high-frequency transients and electromagnetic patterns that indicate discharge within the transformer.

18. A method for training a machine learning model to predict a health of a transformer in a battery energy storage system, the method comprising:
receiving, by one or more processors, first data regarding one or more element attributes associated with the transformer, wherein the first data includes a plurality of operational parameters;
extracting, by the one or more processors, one or more first features from the first data based on analyzing processing algorithms identifying one or more inverter operational parameters;
extracting, by the one or more processors, one or more second features from second data, wherein the second data includes one or more grid operational parameters;
training, by the one or more processors, the machine learning model to determine correlations between the one or more element attributes and one or more health assessment values based on the one or more first features and the one or more second features; and
validating, by the one or more processors, the trained machine learning model using validation data.

19. The method of claim 18, wherein the plurality of operational parameters include one or more of a plurality of DC bus voltage measurements, a plurality of multi-stack current readings, a plurality of three-phase AC measurements, a plurality of line-to-line measurements, or a plurality of grid voltage measurements.

20. The method of claim 18, wherein the one or more health assessment values include one or more of a winding health index, a tap changer index, a contact analysis, or a performance metrics value.
